(19) United States
(12) Patent Application Publication
(10) Pub. No.: US 2024/0013542 A1
(43) Pub. Date: Jan. 11, 2024

(54) INFORMATION PROCESSING SYSTEM, INFORMATION PROCESSING DEVICE, INFORMATION PROCESSING METHOD, AND RECORDING MEDIUM

(71) Applicant: NEC Corporation, Minato-ku Tokyo (JP)

(72) Inventor: Mineto SATOH, Tokyo (JP)

(73) Assignee: NEC Corporation, Minato-ku Tokyo (JP)

(21) Appl. No.: 18/033,007

(22) PCT Filed: Oct. 30, 2020
(86) PCT No.: PCT/JP2020/040897

§ 371 Date: Apr. 20, 2023

(51) Int. Cl. G06V 20/52; G06T 17/00; G01N 21/88

(52) U.S. Cl. CPC G06V 20/52; G06T 17/00; G01N 21/8851

(57) ABSTRACT

An information processing device includes an information generation unit and an abnormality determination unit. The information generation unit generates virtual observation information obtained by observing results from simulating a real environment in which a target device to be evaluated is present. The abnormality determination unit determines an abnormal state corresponding to the difference between the generated virtual observation information and real observation information obtained by observing the real environment.

### TECHNICAL FIELD

The present disclosure relates to a technical field of an information processing system, an information processing device, an information processing method, and a recording medium for control of a target device.

### BACKGROUND ART

In recent years, against the background of a shortage of a working population and an increase in labor cost, automation of an operation of a controlled device such as introduction of a robot is expected. In order to cause the controlled device to automatically execute a target operation (task), an operation called system integration (SI) is necessary in which the entire system is appropriately designed and an operation is set. The SI work includes, for example, setting an operation of the robot arm necessary for executing a target task, work called teaching, and work called calibration in which a coordinate system of the imaging device and a coordinate system of the robot arm are associated with each other. Such SI work requires a high degree of expertise and precise tuning at a real work site. Therefore, in such SI work, an increase in man-hours is a problem.

Therefore, in the SI work, a technique for reducing an increase in man-hours is desired. For example, the SI work includes work in a normal state (hereinafter, also referred to as a normal system) under a prescribed environment, that is, based on a specification, and work in consideration of a so-called abnormal state (hereinafter, also referred to as an abnormal system) under an environment other than the prescribed environment. Since the normal system is based on the specification, the occurrence of abnormality is low, and thus, various improvements in efficiency and automation have been studied.

On the other hand, in the abnormal system, it is difficult to conceive all the conceivable environmental conditions and abnormal states in advance. Therefore, the SI work requires more man-hours to deal with the abnormal system. Therefore, a technology for preventing an increase in SI man-hours beyond expectation by evaluating a state and a control result of a target device and automatically (autonomously) detecting an abnormal state has been proposed.

As such a technique, for example, PTL 1 discloses a control device and a method capable of preventing failure of an operation of a robot in advance. The control device disclosed in PTL 1 defines a state transition in the middle of reaching failure in advance for the task, thereby determining whether the failure is reached each time based on the operation data of the robot.

PTL 2 discloses a component serving device for kitting trays (learning of serving rules). When appropriately disposing (serving) a plurality of types of components having different sizes in a plurality of accommodation portions using a robot arm, the component serving device disclosed in PTL 2 determines whether a target component is gripped based on imaging data of a component recognition camera that images the gripped component from a lower face.

As a related technique, PTL 3 describes an information processing device that identifies, by image recognition using machine learning, a region indicating at least one of objects from an input image obtained by imaging an object group in which two or more objects of the same type are disposed.

As another related technique, PTL 4 describes a control device that generates a friction model from a comparison result between a real environment and a simulation of the real environment, and determines a friction compensation value based on an output of the friction model.

### CITATION LIST

### Patent Literature

PTL 1: WO 2020/031718 A
PTL 2: WO 2019/239565 A
PTL 3: JP 2020-087155 A
PTL 4: JP 2006-146572 A

### SUMMARY OF INVENTION

### Technical Problem

In PTLs 1 and 2, in order to determine the success or failure of the operation of the robot based on data, it is necessary to appropriately set a reference value for determining the success or failure in advance for each environment or task situation. Such a reference value is, for example, a reference value related to a position of the robot or the object when the planned operation of the robot is achieved, a movement distance (reference of timeout time) by the operation of the robot within a prescribed time, or a value of a sensor reflecting an operation state, for example, imaging data of a component recognition camera, a vacuum arrival degree in a gripping operation by a suction hand, time series data of a force sense or a tactile sensor, or the like.

However, the devices disclosed in PTLs 1 and 2 determine the success or failure of the operation of the robot and the task based on the preset reference value and the condition (rule), and thus, it is not possible to reduce the number of man-hours for setting the reference value and the condition. The devices disclosed in PTLs 1 and 2 cannot automatically determine or dynamically update the reference value or the condition before setting the reference value or the condition. Furthermore, the devices disclosed in PTLs 1 and 2 cannot cope with a situation in which no reference value or condition is set.

In view of the above-described problems, an object of the present disclosure is to provide an information processing system, an information processing device, an information processing method, and a recording medium capable of efficiently determining an abnormal state regarding a target device.

### Solution to Problem

An information processing device according to an aspect of the present disclosure includes an information generation means configured to generate virtual observation information obtained by observing a result of simulating a real environment in which a target device to be evaluated exists, and an abnormality determination means configured to determine an abnormal state according to a difference between the generated virtual observation information and real observation information obtained by observing the real environment.

An information processing system according to an aspect of the present disclosure includes a target device to be evaluated and an information processing device according to an aspect of the present disclosure.

An information processing method according to an aspect of the present disclosure includes generating virtual observation information obtained by observing a result of simulating a real environment in which a target device to be evaluated exists, and determining an abnormal state according to a difference between the generated virtual observation information and real observation information obtained by observing the real environment.

A recording medium according to an aspect of the present disclosure records a program for causing a computer to execute the steps of generating virtual observation information obtained by observing a result of simulating a real environment in which a target device to be evaluated exists, and determining an abnormal state according to a difference between the generated virtual observation information and real observation information obtained by observing the real environment.

### Advantageous Effects of Invention

According to the present disclosure, it is possible to efficiently determine an abnormal state related to a target device.

### BRIEF DESCRIPTION OF DRAWINGS

FIG. 1 is a block diagram illustrating an example of a configuration of a target evaluation system 10 according to the first example embodiment.

FIG. 2 is a block diagram illustrating a relationship between a real environment and a virtual environment according to the first example embodiment.

FIG. 3 is a block diagram illustrating an example of a configuration of an information processing device 12 according to the first example embodiment.

FIG. 4 is a flowchart illustrating an observation information evaluation process of the target evaluation system 10 according to the first example embodiment.

FIG. 5 is a block diagram illustrating an example of a configuration of an information processing device 22 according to the second example embodiment.

FIG. 6 is a flowchart illustrating an observation information evaluation process of the information processing device 22 according to the second example embodiment.

FIG. 7 is a diagram illustrating an example of a configuration of a picking system 110 according to the third example embodiment.

FIG. 8 is a diagram for explaining the operation of the picking system 110 according to the third example embodiment.

FIG. 9 is a diagram for explaining the operation of a comparison unit 18 according to the third example embodiment.

FIG. 10 is a diagram illustrating an example of a configuration of a calibration system 120 according to the fourth example embodiment.

FIG. 11 is a diagram for describing an operation of the calibration system 120 according to the fourth example embodiment.

FIG. 12 is a diagram for explaining the operation of a comparison unit 18 according to the fourth example embodiment.

FIG. 13 is a flowchart illustrating estimation processing of a position/posture parameter θ according to the fourth example embodiment.

FIG. 14 is a diagram for explaining a calibration method in a modification of the fourth example embodiment.

FIG. 15 is a diagram illustrating a configuration of a reinforcement learning system 130 according to the fifth example embodiment.

FIG. 16 is a block diagram illustrating a configuration of an information processing device 1 according to the sixth example embodiment.

FIG. 17 is a block diagram illustrating an example of a hardware configuration of a computer 500.

### EXAMPLE EMBODIMENT

Hereinafter, example embodiments of an information processing system, an information processing device, an information processing method, and a recording medium will be described with reference to the drawings. However, the example embodiments described below have technically preferable limitations for carrying out the present disclosure, but the scope of the disclosure is not limited to the following. In the respective drawings and the respective example embodiments described in the specification, the same reference numerals are given to the same components, and the description thereof will be omitted as appropriate.

(First example embodiment) First, a target evaluation system according to the first example embodiment will be described with reference to the drawings.

(System Configuration)

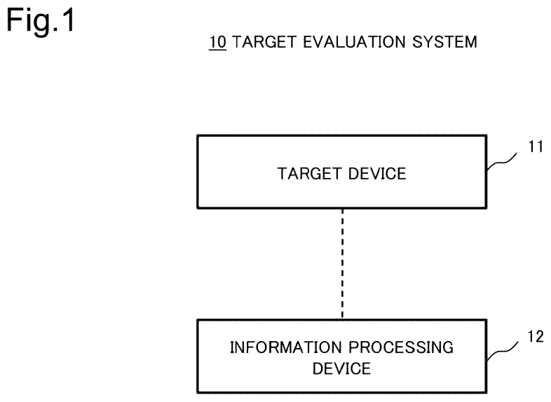

FIG. 1 is a block diagram illustrating an example of a configuration of a target evaluation system 10 according to the first example embodiment. As illustrated in FIG. 1, the target evaluation system 10 includes a target device 11 and an information processing device 12.

The target device 11 is a device to be evaluated. The target device 11 is, for example, an articulated (multi-axis) robot arm that executes a target work (task) or an imaging device such as a camera for recognizing a surrounding environment. When the target device 11 is a robot arm, the robot arm may include a device having a function necessary for performing a task, for example, a robot hand. In a case where the target device 11 is an observation device, the observation device may include a mechanism that is fixed in a work space of a controlled device to be observed and changes a position and a posture, or a mechanism that moves in the work space. The controlled device is a device such as a robot arm that executes a desired task in a case where the target device 11 is an observation device.

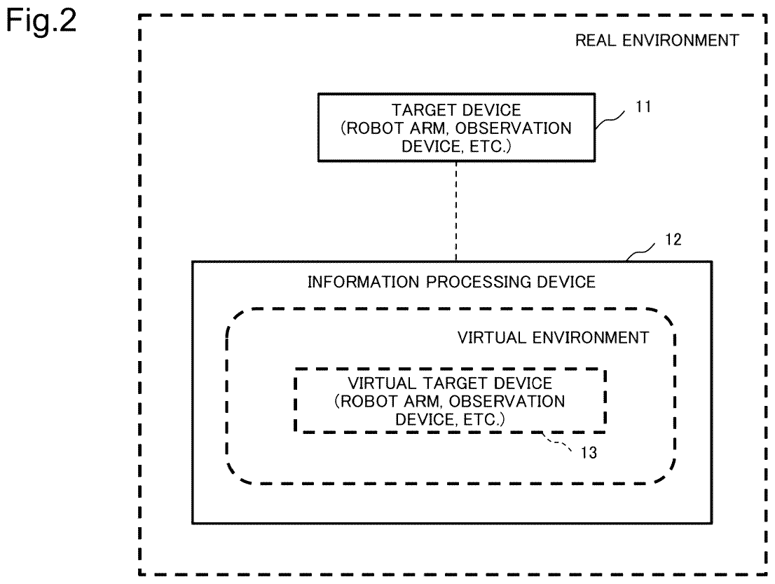

FIG. 2 is a block diagram illustrating a relationship between a real environment and a virtual environment according to the first example embodiment. As illustrated in FIG. 2, the information processing device 12 constructs a virtual target device 13 simulating the target device 11 in a virtual environment obtained by simulating a real environment. In a case where the target device 11 is a robot arm, the information processing device 12 constructs the virtual target device 13 that simulates the robot arm. In a case where the target device 11 is an observation device, the information processing device 12 constructs the virtual target device 13 that simulates the observation device of the target device 11. In this case, the information processing device 12 constructs, in the virtual environment, a robot arm or the like that is a controlled device to be observed.

The information processing device 12 compares the information about the target device 11 in the real environment with the information about the virtual target device 13, and determines an abnormal state regarding the target device 11.

The real environment means the real target device 11 and its surrounding environment. The virtual environment means, for example, an environment in which the target device 11 such as a robot arm, a picking object of the robot arm is reproduced by simulation (simulator or mathematical model), a so-called digital twin, or the like. Specific configurations of these devices are not limited in the present example embodiment.

(Device Configuration)

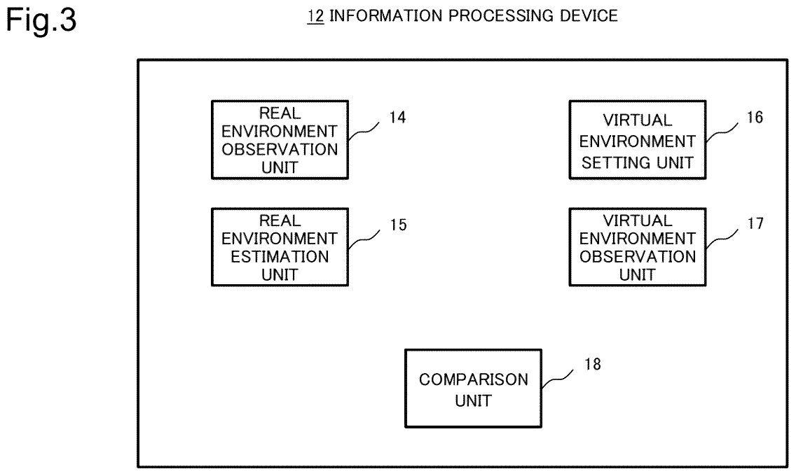

Next, a configuration of the information processing device 12 according to the first example embodiment will be described more specifically with reference to FIG. 3. FIG. 3 is a block diagram illustrating an example of a configuration of the information processing device 12 according to the first example embodiment.

Hereinafter, in the present example embodiment, a case where the target device 11 is a robot arm will be described, and in the fourth example embodiment to be described later, a case where the target device 11 is an observation device will be described.

As illustrated in FIG. 3, the information processing device 12 includes a real environment observation unit 14, a real environment estimation unit 15, a virtual environment setting unit 16, a virtual environment observation unit 17, and a comparison unit 18.

The real environment observation unit 14 acquires an observation result (hereinafter, also described as real observation information) regarding the target device 11 in the real environment. The real environment observation unit 14 acquires, for example, an operation image of the robot arm, which is an observation result, as real observation information, using, for example, a general 2D camera (RGB camera), a 3D camera (depth camera), or the like (not illustrated). The observation result is, for example, image information obtained by visible light, infrared rays, X-rays, laser, or the like.

The real environment observation unit 14 acquires the operation of the robot arm as operation information from a sensor provided in the actuator of the robot arm. The operation information is information in which, for example, values indicated by the sensor of the robot arm at a certain time point are put together in time series to represent the operation of the robot arm.

The real environment estimation unit 15 estimates an unknown state in the real environment based on the real observation information acquired by the real environment observation unit 14, and obtains an estimation result. In the present example embodiment, the unknown state is a specific state that should be known in order to perform a task in a real environment in a virtual environment but that is unknown or highly uncertain, and represents a state that can be directly or indirectly estimated from an observation result, for example, an image or the like.

For example, in a case where the target device 11 is a robot arm and the task to be executed is picking (processing of picking up an object), the unknown or highly uncertain state includes a position, a posture, a shape, a weight, and surface characteristics (friction coefficient and the like) of the picking object. Among these states, the unknown state is a state that can be estimated directly or indirectly from the observation result (image information), that is, a position, a posture, and a shape. The real environment estimation unit 15 outputs the estimation result obtained by estimating the unknown state described above to the virtual environment setting unit 16.

For the virtual environment, it is assumed that a necessary part in the real environment can be simulated. However, it is not necessary to simulate all the necessary parts in the real environment. The real environment estimation unit 15 can define a predetermined range to be simulated, that is, a necessary part, based on a device to be evaluated or a target work (task). As described above, since there is a state with high unknown or high uncertainty in the predetermined range to be simulated, the real environment estimation unit 15 is required to estimate the unknown state in order to simulate the real environment in the predetermined range. A specific estimation result and a specific estimation method will be described later.

The virtual environment setting unit 16 sets the estimation result estimated by the real environment estimation unit 15 in the virtual environment in such a way that the state of the virtual environment comes close to that of the real environment. The virtual environment setting unit 16 operates the virtual target device 13 based on the operation information acquired by the real environment observation unit 14. The virtual target device 13 in the virtual environment illustrated in FIG. 2 is a model constructed by simulating the target device 11 by a well-known technique in advance, and can perform the same operation as the target device 11 based on the operation information by the real environment observation unit 14.

The virtual environment setting unit 16 may use the known state and the planned state for setting the virtual environment. The planned state is, for example, a control plan for controlling the target device 11 such as a robot arm, a task plan, or the like. In this way, the virtual environment setting unit 16 constructs a virtual environment obtained by simulating a real environment in a predetermined range.

In the virtual environment of the present example embodiment, the virtual environment setting unit 16 performs a simulation regarding the virtual target device 13 in accordance with the elapse of time of the real environment (by time evolution of the real environment). In a case where the state set by the virtual environment setting unit 16 is appropriate, in the virtual environment, an ideal future (future) state can be obtained as compared with the real environment. This is because an unexpected state, that is, an unset state (abnormal state) does not occur in the virtual environment.

On the other hand, in the real environment, there is a possibility that an abnormal state occurs due to a situation that is difficult to set by the virtual environment setting unit 16, that is, for example, an environment change, a disturbance, uncertainty (individual difference in device, an error of position information, and the like), and a failure, an error, or the like of hardware such as the target device 11 such as a robot arm.

The virtual environment observation unit 17 acquires observation information (hereinafter, also described as virtual observation information) regarding the virtual target device 13 from an observation means in the virtual environment obtained by simulating the observation device of the real environment. The virtual environment observation unit 17 may be any means that models the observation device, and is not limited in the present disclosure.

The virtual environment observation unit 17 acquires, in the virtual environment, image information (virtual observation information) of the same type as image information (real observation information) that is an observation result of observing the real environment. For example, in a case where the image information is information captured by a 2D (RGB) camera, the image information of the same type is image information, with a similar 2D (RGB) camera model disposed in a virtual environment, specifically, a simulator, captured by the camera model in the simulator. The same applies to another real observation information, for example, image information captured by a 3D (depth) camera. Specifications of information imaged by an imaging device such as a camera, for example, a resolution, an image size, and the like of an image only need to have commonality in a predetermined range according to an evaluation target or a task, and do not need to completely the same. Specific virtual environments, real observation information, virtual observation information, and abnormalities will be described in the following example embodiments.

The real observation information and the virtual observation information are input to the comparison unit 18. The comparison unit 18 compares the input real observation information with the input virtual observation information to output a comparison result. When no abnormal state occurs in the real environment in time series (time evolution), the real observation information and the virtual observation information do not differ from each other under a predetermined range and condition, that is, in a range simulated in the virtual environment. However, when an abnormal state occurs in the real environment, the real observation information and the virtual observation information are different from each other because the state of the real environment is different from the setting reflected in the virtual environment. Therefore, the comparison unit 18 outputs the presence or absence of the abnormal state in the real environment as a difference between the real observation information and the virtual observation information, which are comparison results.

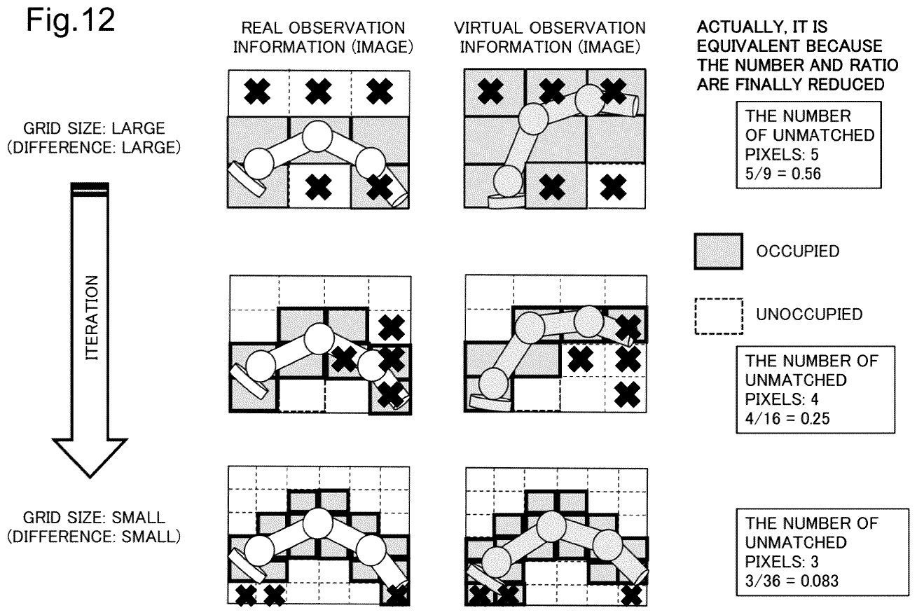

A comparison method in the comparison unit 18 will be described as an example. As described above, it is assumed that the real observation information and the virtual observation information are data having commonality in a predetermined range. For example, in a case where the observation device is 2D (RGB) camera data (two-dimensional image data), the comparison unit 18 can perform averaging to a certain common resolution or compare pixel values of two-dimensional images down-sampled. More simply, the comparison unit 18 can easily and quickly perform comparison by converting a pixel into an occupancy map represented by a binary value according to whether the pixel constitutes an image of a target object, that is, whether the pixel is occupied. Even in a case where the observation information is 3D (2D image+depth) or a point cloud (Point Cloud), the comparison unit 18 can similarly perform comparison by using an expression such as a three-dimensional occupancy grid. Although the comparison method is not limited thereto, a specific example will be described in the example embodiment described later with reference to FIG. 12 and the like.

(Operation)

Next, an operation of the first example embodiment will be described.

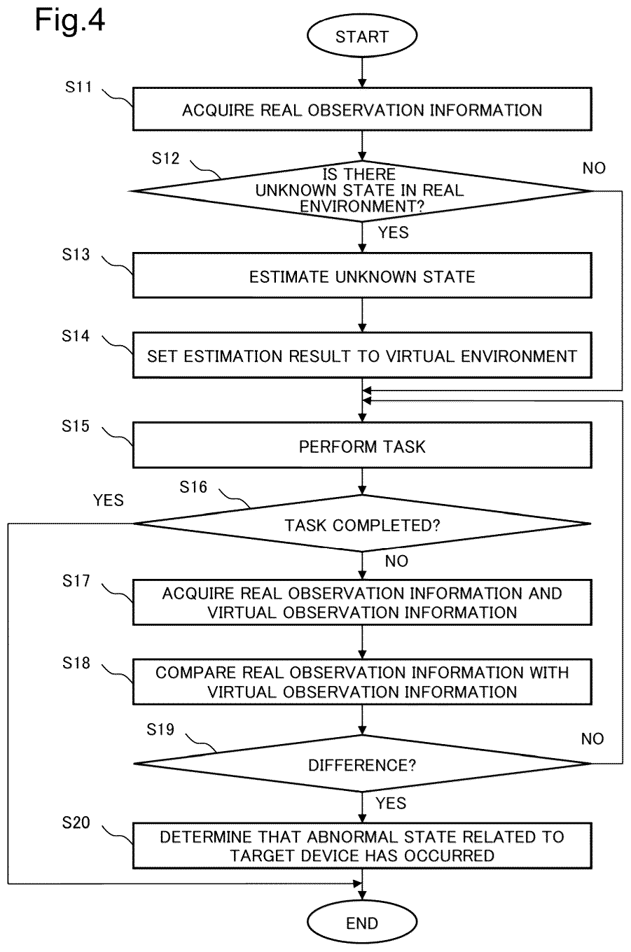

FIG. 4 is a flowchart illustrating an observation information evaluation process of the target evaluation system 10 according to the first example embodiment.

(Observation Information Evaluation Process)

First, in the target evaluation system 10, the real environment observation unit 14 of the information processing device 12 acquires real observation information about the target device 11 (step S11).

When there is an unknown state in the real environment (YES in step S12), the real environment estimation unit 15 estimates the unknown state (step S13). The real environment estimation unit 15 determines the presence or absence of the unknown state in order to acquire virtual observation information about the virtual target device 13. For example, in the case of a picking operation (operation of picking up an object), the real environment estimation unit 15 can determine the position/posture of each joint of a robot arm or the like as a known state based on operation information or a control plan. However, it is necessary to determine the position/posture of the picking object based on the real observation information obtained from the observation device, and it is not possible to accurately identify the position/posture. Therefore, it is possible to determine that it is an unknown state. After determining that the position/posture of the picking object is an unknown state, the real environment estimation unit 15 estimates the position/posture based on the real observation information.

The unknown state in the present disclosure can be determined directly or indirectly from the image, as described above. For the estimation of the unknown state, a feature-based or deep learning-based image recognition (computer vision) method using real observation information (image information) observed for the target device 11 (observation device) or the object can be applied.

In the case of the picking operation (operation of picking up an object), for example, estimation of an unknown state can be achieved by matching 2D (RGB) data or 3D (RGB+depth, or point cloud) data as real observation information (image information) with model data created by computer aided design (CAD) or the like representing the picking object. Deep learning, in particular, a technique of classifying (segmenting) an image using a convolution neural network (CNN) or a deep neural network (DNN) is applied to real observation information (image information), and thus, it is possible to separate a region of a picking object from other regions and to estimate a position/posture of the picking object. By attaching a sign, for example, an AR marker or the like to the picking object and detecting the position/posture of the sign, the position/posture of the picking object can be estimated. An unknown state estimation method is not limited in the present disclosure.

When there is no unknown state in the real environment (NO in step S12), the real environment estimation unit 15 advances the process to step S15 of the comparison process. The case where there is no unknown state in the real environment is, for example, a case where the position/posture of the picking object are determined and a known state is obtained in the case of the above-described picking operation.

The virtual environment setting unit 16 sets the estimation result of the unknown state in the virtual environment (step S14). For example, in the case of the above-described picking operation, the virtual environment setting unit 16 sets the estimation result of the position/posture of the picking object as the position/posture of the picking object in the virtual environment.

In the information processing device 12, by setting the virtual environment to be close to the real environment by the processing from step S11 to step S14, an environment in which the real observation information and the virtual observation information can be compared with each other is constructed. That is, in the processing from step S11 to step S14, the initial setting of the virtual environment is performed.

The target device 11 and the virtual environment setting unit 16 execute a task (step S15). The task in the real environment is, for example, a picking operation or calibration of an observation device as described later. The task in the real environment may be executed by inputting a control plan stored in advance in a memory (not illustrated), for example. For example, in the case of a picking operation, the task in the virtual environment is executed by the virtual environment setting unit 16 setting operation information obtained from a robot arm or the like that is the target device 11 in the virtual target device 13. During the execution of the task, the target device 11 is caused to perform the task according to the control plan, the operation information about the target device 11 is acquired, and setting it in the virtual target device 13 is repeated. For example, in the case of the picking operation, the task is a series of operations in which the robot arm or the like approaches the vicinity of the picking object, then grips and lifts the picking object, and then moves to a predetermined position.

The information processing device 12 determines whether the task is completed (step S16). In a case where the task is completed (YES in step S16), the information processing device 12 ends the observation information evaluation process. Regarding the termination of the task, for example, the information processing device 12 may determine that the task is completed when the last control command of the control plan of the picking operation has been executed.

When the task is not completed (NO in step S16), the real environment observation unit 14 acquires the real observation information about the target device 11, and the virtual environment observation unit 17 acquires the virtual observation information about the virtual target device 13 (step S17).

The comparison unit 18 compares the real observation information with the virtual observation information (step S18). The comparison unit 18 compares the real observation information with the virtual observation information by, for example, converting each pixel into an occupancy map as described above. Details of the conversion into the occupancy map will be described in the following example embodiments.

When there is a difference in the comparison in step S18 (YES in step S19), the comparison unit 18 determines that an abnormal state related to the target device 11 has occurred (step S20). When determining that the abnormal state has occurred, the comparison unit 18 ends the observation information evaluation process.

In a case where there is no difference in the comparison in step S18 (NO in step S19), the comparison unit 18 returns to the processing of execution of the task in step S15 and continues the subsequent processing.

Thus, the operation of the first example embodiment is completed.

As described above, in the observation information evaluation process, a difference occurs in step S19 and the state is determined to be an abnormal state, or the process ends when the task is completed in step S16. In a case where the task is completed in step S16, it means that there is no difference between the real observation information and the virtual observation information during the execution of the task, that is, the target device 11 has executed the task without an abnormal state generated.

A series of operations in the observation information evaluation process (processing from step S15 to step S20) may be performed at a certain time (timing), or may be repeated at a prescribed time cycle. For example, in the case of the picking operation as described above, the process may be performed for each operation of approach, grasping, lifting, and moving. As a result, the information processing device 12 can determine whether the operation of the target device 11 is successful, that is, there is an abnormal state, at the time when the present operation is performed, that is, at each timing such as approach, grasping, and movement. As a result, the information processing device 12 can reduce useless operations after the occurrence of the abnormal state.

A difference between the technology of the present disclosure and a general simulation technology including artificial intelligence (AI) and the like will be described. In a general simulation technique, comparison between information (data) of a virtual environment, that is, a mathematically calculated environment, and information about a real environment can be performed by various techniques.

However, these technologies cannot directly compare the information about the real environment with the information about the virtual environment, and thus always include, for example, information conversion processing from the real environment to the virtual environment. For this information conversion processing, it is necessary to set conditions and reference values according to the environment and the task based on assumption by professional knowledge and interpretation in advance. That is, the above-described related art cannot objectively and uniquely compare the information about the real environment with the information about the virtual environment.

For example, in the case of a simulation result, output data is generally different from image information such as real observation information according to the present example embodiment. Therefore, in a general simulation technique, in order to compare the observation information about the real environment with the output data, it is necessary to designate a range for evaluating the simulation or to convert the output data into the observation information.

In the case of machine learning, so-called prediction using AI, there is uncertainty in the prediction itself. Similarly, also in the case of using the technology of image recognition by AI, there is uncertainty in the image recognition itself. Furthermore, for example, in order to make a determination from an image by an observation device in the real environment, it is necessary to set conditions and reference values according to the environment and the task based on assumption by professional knowledge and interpretation in advance.

Therefore, since preconditions and uncertainty cannot be completely eliminated in a general simulation technology including AI or the like, artificial setting, determination, and the like are required, thereby preventing reduction in SI man-hours. Such a technology requires a large amount of calculation resources for prediction and evaluation, and thus, the cost and calculation time are problems.

On the other hand, in the technology of the present disclosure, by using information (data) of the same type in the real environment and the virtual environment, it is possible to directly compare the data itself (raw data) without performing human intervention of setting conditions and reference values according to the environment and the task based on assumption by professional knowledge and interpretation in advance. As a result, in the present disclosure, uncertainty and calculation resources can be reduced.

(Effects of First Example Embodiment)

According to the first example embodiment, it is possible to efficiently determine the abnormal state related to the target device. This is because virtual observation information obtained by observing a result of simulating the real environment in which the target device 11 to be evaluated exists is generated, and an abnormal state is determined according to a difference between the generated virtual observation information and the real observation information obtained by observing the real environment.

That is, in the virtual environment set by the virtual environment setting unit 16, ideal virtual observation information that is an ideal current or future (future) state in which no abnormal state occurs is obtained, while in the real environment, real observation information including various abnormal states such as an environment change, a disturbance and an uncertainty such as an error, and a failure, an error, or the like of hardware is obtained. Therefore, the effects of the present example embodiment can be obtained by focusing on the difference between the state of the real environment including the target device 11 and the state of the virtual environment including the virtual target device.

### SECOND EXAMPLE EMBODIMENT

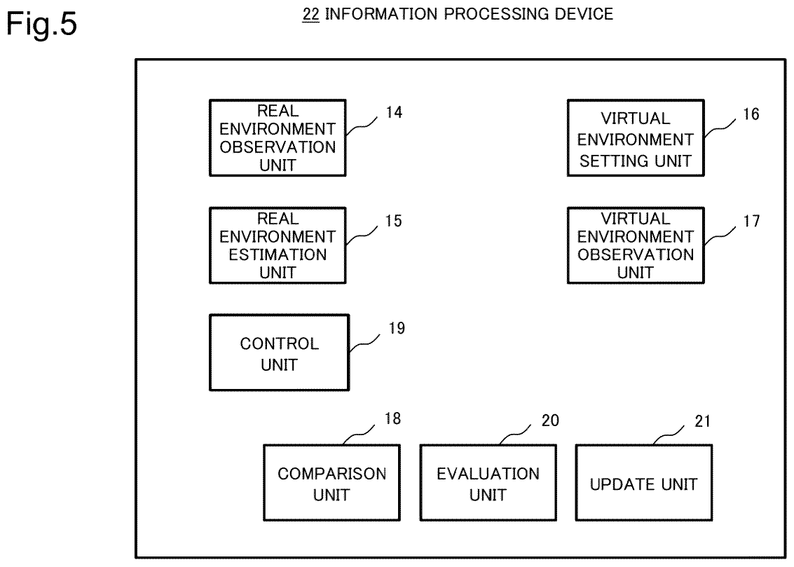

Next, a target evaluation system according to the second example embodiment will be described with reference to the drawings. A target evaluation system 100 according to the second example embodiment is different from that of the first example embodiment in that it includes an information processing device 22 in which a control unit 19, an evaluation unit 20, and an update unit 21 are added to the configuration of the information processing device 12 instead of the information processing device 12 according to the first example embodiment. The configuration of the information processing device 22 will be described more specifically with reference to FIG. 5. FIG. 5 is a block diagram illustrating an example of a configuration of the information processing device 22 according to the second example embodiment.

(Device Configuration)

As illustrated in FIG. 5, the information processing device 22 newly includes the control unit 19, the evaluation unit 20, and the update unit 21 in addition to the configuration of the information processing device 12 in the first example embodiment. Components having the same reference numerals have the same functions as those of the first example embodiment, and thus, the description thereof will be omitted below.

The control unit 19 outputs a control plan for controlling the target device 11 and a control input for real control to the target device 11. These outputs may be values at a certain time (timing) or time series data. In a case where the target device 11 is a robot arm or the like, the control unit 19 outputs a control plan or a control input to the target device 11 that is a controlled object. A typical method, for example, so-called motion planning such as rapidly-exploring random tree (RRT) can be used for calculation of the control plan and the control input. In the present example embodiment, the control plan and the method of calculating the control input are not limited.

The evaluation unit 20 receives the comparison result output from the comparison unit 18 to output an evaluation value. The evaluation unit 20 calculates the evaluation value based on a difference between the real observation information and the virtual observation information that are comparison results. As the evaluation value, the difference that is the comparison result may be used as it is, or the degree of abnormality (hereinafter, also referred to as abnormality degree) calculated based on the difference may be used. For example, in a case where the target device 11 is a robot arm or the like, the evaluation value represents the degree of deviation in the position/posture of the picking object between the real observation information and the virtual observation information. In a case of a system that performs reinforcement learning of the operation of the target device 11, a reward for the operation may be determined based on the evaluation value. The reward is, for example, an index indicating how far the target device 11 is from the desired state. In the case of the above-described example, for example, the reward is set lower as the degree of deviation is larger, and the reward is set higher as the degree of deviation is smaller. The evaluation value is not limited thereto.

The update unit 21 outputs information for updating at least one of the estimation result estimated by the real environment estimation unit 15 or the control plan planned by the control unit 19 in such a way as to change the evaluation value output from the evaluation unit 20 in an intended direction. The intended direction is a direction in which the evaluation value (difference or abnormality) is lowered.

The update information in the intended direction may be calculated by a typical method, for example, a gradient method or the like using a parameter representing an unknown state or a gradient (or partial differentiation) of an evaluation value with respect to a parameter for determining the control plan. A method of calculating the update information is not limited. The parameter of the unknown state represents, for example, a position, a posture, a size, and the like in a case where the unknown state is the position/posture of the picking object. For example, in the case of picking by the robot arm, the parameter of the control plan represents a position/posture of the robot arm (control parameter of the actuator of each joint), a gripping position and angle, an operation speed, and the like.

For example, the update unit 21 may use a gradient method to select a parameter (hereinafter, also described as a parameter with high sensitivity) having a large gradient of change in the evaluation value (difference or abnormality) in an intended direction for an unknown state or a control plan, and may instruct the real environment estimation unit 15 or the control unit 19 about the parameter to be changed according to the selected parameter. In the selection of the update parameter, a plurality of parameters considered to have high sensitivity may be determined in advance, a value may be changed with respect to the parameters, a gradient of change in the evaluation value (difference or abnormality) at that time may be calculated, and the parameter having the highest sensitivity may be preferentially updated.

The update unit 21 may repeat processing of selecting an update parameter and updating the selected parameter instead of instructing the real environment estimation unit 15 or the control unit 19 about the parameter to be changed.

(Operation)

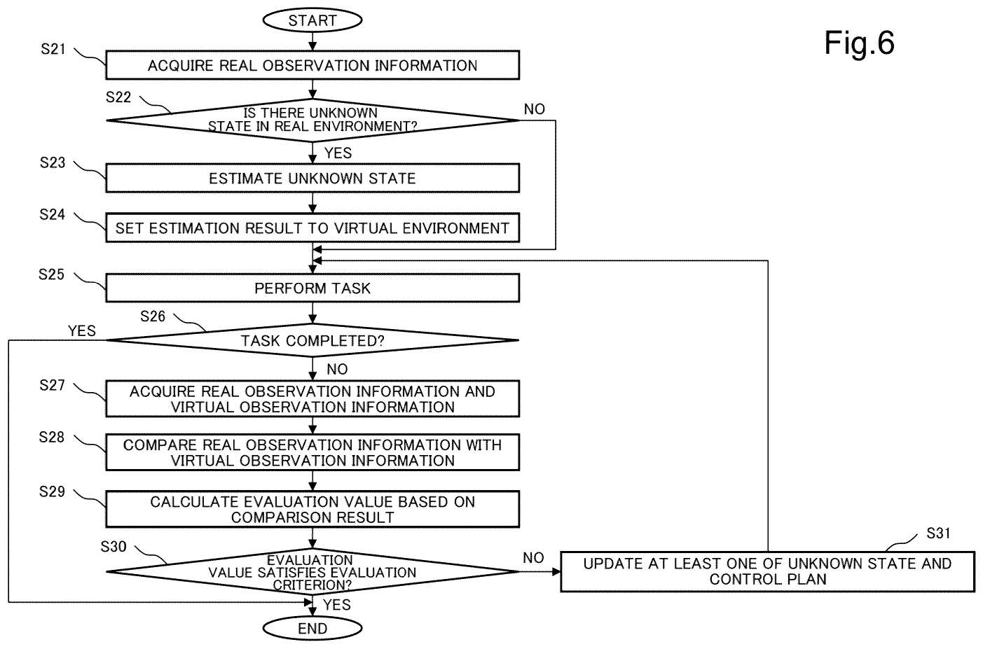

FIG. 6 is a flowchart illustrating the observation information evaluation process of the information processing device 22 according to the second example embodiment.

In the flowchart illustrated in FIG. 6, the operations from the real observation information acquisition process (step S21) by the real environment observation unit 14 to the comparison process (step S28) by the comparison unit 18 are the same as the operations from step S11 to step S18 of the observation information evaluation process by the target evaluation system 10 according to the first example embodiment, and thus, description thereof is omitted. However, in step S24 of the virtual environment setting process, in addition to the estimation result (step S14) by the real environment estimation unit 15 of the first example embodiment, the control plan by the control unit 19 is set in the virtual environment.

The evaluation unit 20 calculates an evaluation value based on the comparison result (step S29). The evaluation unit 20 evaluates whether the evaluation value satisfies a predetermined evaluation criterion (hereinafter, it is also simply described as a predetermined criterion) (step S30). The evaluation criterion is a criterion of a difference that is a comparison result for determining that the abnormal state related to the target device 11 is “not abnormal”, or an abnormality value calculated based on the difference. The evaluation criterion is different from the reference values and conditions according to the environment and the task in PTL 1 and PTL 2 described above. The evaluation criterion is indicated by, for example, a threshold value related to a range of values of a difference and an abnormality in which an abnormal state is determined to be “not abnormal”. For example, in a case where the evaluation criterion is defined by an upper limit threshold value, the evaluation unit 20 evaluates that the evaluation criterion is satisfied in a case where the evaluation value is equal to or less than the threshold value. The evaluation criterion may be set in advance based on the target device 11 to be evaluated and the task. The evaluation criterion may be set or changed in the process of operating the target evaluation system 100. In this case, for example, the evaluation criterion may be set according to the difference in the comparison result. Furthermore, the evaluation criterion may be set from past record data, trends, and the like, and is not particularly limited.

When the evaluation value does not satisfy the evaluation criterion (NO in step S30), the update unit 21 updates at least one of the unknown state and the control plan based on the evaluation value (step S31). Thereafter, the processing from step S25 is repeated. As a result, the difference between the real observation information and the virtual observation information is reduced, and the evaluation value satisfies the evaluation criterion, whereby the abnormal state regarding the target device 11 is resolved.

(Effects of Second Example Embodiment)

According to the second example embodiment, in addition to being able to efficiently determine the abnormal state related to the target device, it is possible to automatically (autonomously) recover from the abnormal state to the normal state, and thus, it is possible to further reduce the SI man-hours. The reason is that the evaluation unit 20 evaluates whether the evaluation value satisfies the evaluation criterion, and in a case where the reference value is not satisfied, the update unit 21 updates at least one of the estimation result and the control plan based on the evaluation value, whereby the observation information evaluation process is repeated until the evaluation value satisfies the evaluation criterion.

### THIRD EXAMPLE EMBODIMENT

Next, as the third example embodiment, a specific example based on the second example embodiment will be described.

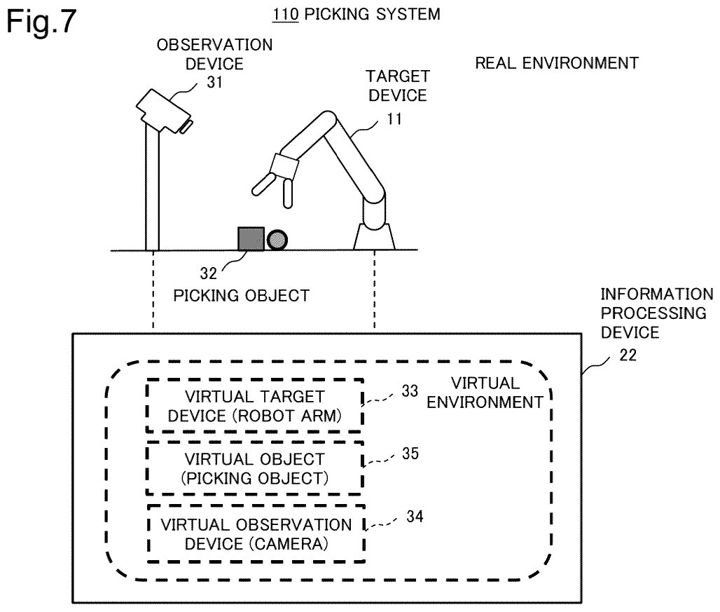

The third example embodiment is an example in which a robot arm that executes picking in a picking operation (operation of picking up an object), which is one of tasks executed in a manufacturing industry, a distribution industry, and the like, is evaluated as the target device 11. FIG. 7 is a diagram illustrating an example of a configuration of a picking system 110 according to the third example embodiment.

(Device Configuration)

As illustrated in FIG. 7, the picking system 110 includes a robot arm that is the target device 11, the information processing device 22, an observation device 31 that obtains real observation information about the target device 11, and a picking object 32. The information processing device 22 construct a virtual target device 33 that is a model of a robot arm of the target device 11, a virtual observation device 34 that is a model of the observation device 31, and a virtual object 35 that is a model of the picking object 32 in a virtual environment.

The observation device 31 is a means configured to provide real observation information, about the target device 11, acquired by the real environment observation unit 14 in the first and second example embodiments. For example, the observation device 31 is a camera or the like, and acquires certain time or time-series observation data for a series of picking operations. The series of picking operations means that the robot arm appropriately approaches the picking object 32, picks the picking object 32, and moves or places the picking object 32 to a predetermined position.

The unknown state in the picking system 110 is the position/posture of the picking object 32. The evaluation value of the present example embodiment is whether the series of picking operations described above has succeeded, that is, binary information indicating whether it is a normal state or an abnormal state, accuracy of the operation, a ratio of success in a plurality of operations, or the like. The operation in such a case will be specifically described below.

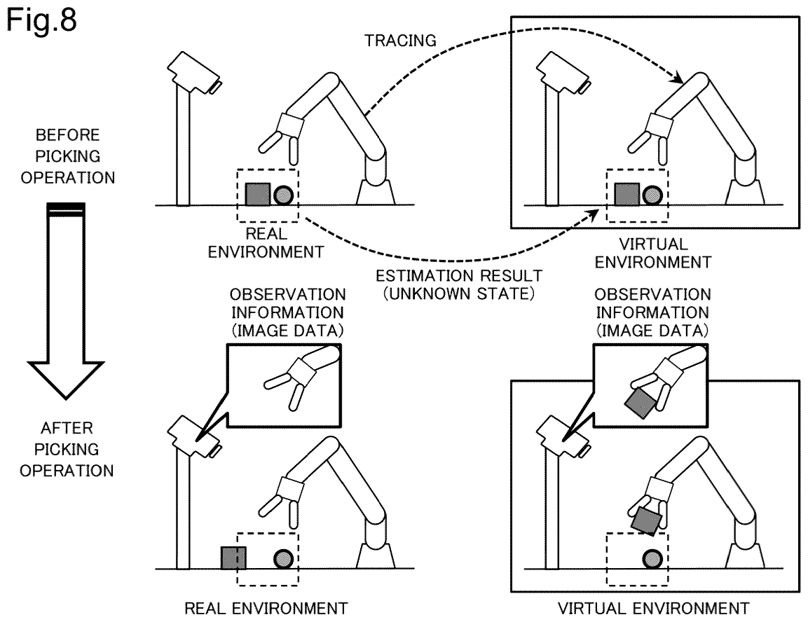

FIG. 8 is a diagram for explaining the operation of the picking system 110 according to the third example embodiment. Hereinafter, the operation of the picking system 110 will be described with reference to the flowchart illustrated in FIG. 6. In the upper part of FIG. 8, a figure (upper left) representing the real environment before the picking operation and a figure (upper right) representing the virtual environment are illustrated. The robot arm which is the target device 11 includes a robot hand or a vacuum gripper suitable for gripping the picking object 32.

In step S21 described above, the real environment observation unit 14 of the information processing device 22 acquires the real observation information about the robot arm that is the target device 11 and the picking object 32 observed by the observation device 31. Next, in step S22 described above, the presence or absence of an unknown state is determined. It is assumed that there is an unknown state.

In step S23 described above, the real environment estimation unit 15 estimates the position/posture of the picking object 32 that is an unknown state based on the acquired real observation information. A feature-based or deep learning-based image recognition (computer vision) method or the like as described in the first example embodiment may be used for the estimation of the position/posture of the picking object 32.

Next, in step S24 described above, the virtual environment setting unit 16 sets the estimation result of the unknown state by the real environment estimation unit 15 in the virtual target device 33. As a result, the initial state of the real environment is set to the virtual environment of the information processing device 22. That is, the virtual environment is set in such a way that the virtual target device 33 can also execute the task of the target device 11 in the real environment in the virtual environment.

After setting the virtual environment, in step S25 described above, the robot arm (target device 11) starts the task, for example, based on the control plan. During execution of the task, the real environment observation unit 14 acquires the position/posture of each joint as operation information via a controller of a robot arm (not illustrated). The virtual environment setting unit 16 sets the acquired operation information in the model of the robot arm that is the virtual target device 33. As a result, it is possible that movement of the robot arm (virtual target device 33) and the virtual object 35 in the virtual environment traces (synchronizes) movement of the robot arm (target device 11) and the picking object 32. The real environment observation unit 14 may acquire the operation information together with the operation of the robot arm at a predetermined cycle, and the virtual environment setting unit 16 may set the operation information in the virtual target device 33 at the same cycle.

In step S26 described above, the information processing device 22 determines whether the task is completed. When the task is not completed, in step S27 described above, the camera (observation device 31) observes the state of the robot arm including the picking object 32 to output the real observation information to the real environment observation unit 14. The virtual observation device 34 observes states of the robot arm (virtual target device 33) and the virtual object 35 by simulation to output virtual observation information to the virtual environment observation unit 17.

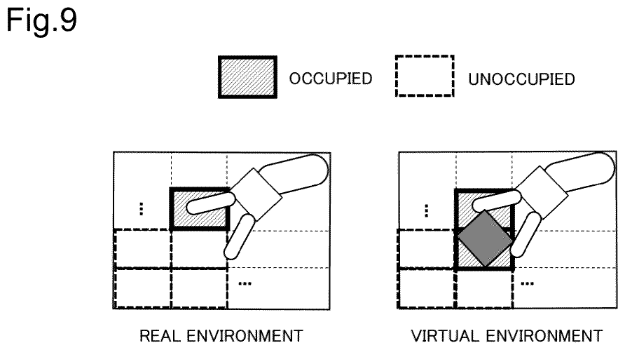

In step S28 described above, the comparison unit 18 compares the real observation information (left balloon in the lower part of FIG. 8) with the virtual observation information (right balloon in the lower part of FIG. 8), and obtains a comparison result. This operation will be described with reference to the lower part of FIG. 8 and FIG. 9. FIG. 9 is a diagram for explaining the operation of the comparison unit 18 according to the third example embodiment.

The lower part of FIG. 8 illustrates a figure (lower left) illustrating the real environment after the picking operation and a figure (lower right) illustrating the virtual environment. In a balloon of the observation device 31, imaging data (image data) as an example of observation information is schematically represented in each of the real environment and the virtual environment. The lower left part of FIG. 8 illustrates a state in which, when a square object of the picking object 32 is approached and picking (gripping) is executed, the operation fails and the square object is dropped in a real environment. As a cause of the failure, for example, it is conceivable that a relationship of a coordinate system between the robot arm (target device 11) and the observation device 31, that is, accuracy of calibration is poor, or accuracy of a position and a posture of an object estimated based on image recognition or the like is poor, so that the position of the approach is deviated, or an assumption of a friction coefficient or the like of the picking object 32 is not correct, or the like. The former is a case where the accuracy of the estimation result of the unknown state is poor. The latter is a case where there is (has been) no unknown state but there is a problem in another parameter. The latter case is taken as an example. The another parameter is a parameter other than the parameters representing the unknown state, and is a parameter that cannot be directly or indirectly estimated from the image data. In the present example embodiment, a case where the real friction coefficient of the picking object 32 is different from the assumed friction coefficient will be described.

It is generally not easy to accurately grasp and model all parameters related to the picking object 32 such as a friction coefficient including an unknown state, and reproduce the parameters in a virtual environment (simulator). Therefore, in the virtual environment, the simulation of the picking operation is performed based on the parameter, regarding the picking object 32, assumed first and the operation information planned by the control unit 19 to be output based on the control input actually input to the robot arm. As a result, since the difference in parameters regarding the picking object 32 as described above is not reflected, that is, the parameters such as the friction coefficient are not considered, the picking succeeds in the virtual environment. The lower right part of FIG. 8 is a figure illustrating that picking has succeeded in the virtual environment. As described above, in the picking according to the present example embodiment, after the picking operation illustrated in the lower part of FIG. 8, the real observation information (lower left of FIG. 8) and the virtual observation information (lower right of FIG. 8) are in different states.

Such a state can be said to be an error (failure or abnormality) because the intended picking operation cannot be achieved in the real environment. It is generally not easy for a machine (robot, AI) to automatically (autonomously) detect such an abnormal state instead of causing a person to discover the abnormal state. Since the picking object 32 does not appear in the imaging data (image data) acquired by the observation device 31 as illustrated in the lower left part of FIG. 8, the person can easily determine that the task fails. On the other hand, in order for a machine (robot, AI) to automatically determine whether the task is successful from such image information, it is generally required to use an image recognition method.

This image recognition is used as one of methods for obtaining the position/posture of the picking object 32 before picking illustrated in the upper part of FIG. 8. However, in the image recognition after picking, it is necessary to recognize an object under the condition that the object gripped by the robot hand, that is, part of the object is shielded. In this respect, the image recognition before picking is different from the image recognition after picking. In general, image recognition may fail to recognize a target when such shielding or the like occurs. This is because, as described above, the related abnormality detection method cannot be directly determined from the original image information (raw data), and is processing performed by recognizing a target in an image via a recognition algorithm or the like. In image recognition, even when it can be recognized that there is no target object, when time is required for recognition, the operation may continue while failing because the robot arm continues to operate. That is, in the related art method, it is difficult to achieve both the detection accuracy of the abnormal state and the shortening of the time until the detection, and to reliably detect the abnormal state in each operation.

As illustrated in FIG. 9, in this operation example, in the comparison unit 18, the real observation information and the virtual observation information are 2D (two-dimensional) image data. The comparison unit 18 converts the real observation information and the virtual observation information into occupancy (occupancy grid map) represented by a binary value of whether the pixel is occupied according to the presence or absence of the object of each pixel, and compares the real observation information with the virtual observation information. However, this is merely an example, and even in the case of 3D (three-dimensional) data, for example, the real observation information and the virtual observation information can be converted into the occupancy, and an expression method such as voxel or octree can be used. The method of conversion into the occupancy is not limited.

In FIG. 9, the left side illustrates a surrounding image of the robot hand in the real environment, and the right side illustrates a surrounding image of the robot hand in the virtual environment. The inside of the image is expressed by being divided into a lattice shape (grid shape). The grid size may be set in any manner according to the size and task of the target device 11 to be evaluated and the picking object 32. As described in the fourth example embodiment, processing in which comparison is repeated a plurality of times while changing the lattice size (grid size), that is, so-called iteration processing, may be performed. In this case, in particular, the accuracy of the occupancy is improved by repeatedly calculating the difference in occupancy while gradually reducing the grid size. This is because, for the accuracy of the occupancy, the pixel occupied by the target object can be more accurately calculated by making the grid size small and increasing the resolution of the pixel in the image data.

In FIG. 8, an unoccupied grid, that is, a grid in which no object is illustrated in an image, is represented by a dotted line frame with white background, and an occupied grid, that is, a grid in which an object is illustrated in an image, is represented by a thick line frame with hatching. In the case of this example, since the picking object 32 is not gripped in the real environment, occupancy by the distal end portion of the robot hand is illustrated as an example. On the other hand, in the virtual environment, since the gripped picking object 32 appears, it is indicated that the grid is also occupied. Therefore, the real observation information and the virtual observation information can be compared only with this difference in occupancy. This means that a difference between the real observation information and the virtual observation information appears as a difference in occupancy without quantitatively evaluating a height, a difference, or the like of the occupancy in mutual environments and without depending on the task, the target device 11, or the picking object 32. Therefore, without providing the virtual observation information with a precondition or the like, and without converting the virtual observation information using the algorithm, and it is possible to determine the presence or absence of the abnormal state regarding the target device 11 by the difference in the uniquely determined occupancy.

For example, in this case, the comparison unit 18 can determine that it is the normal state when there is no difference in occupancy, and it is the abnormal state when there is a difference. The presence or absence of such a difference in occupancy can be calculated at high speed. Although the amount of calculation increases in the case of three dimensions, expressions such as voxels and octree are devised in such a way as to reduce the amount of calculation, and there are algorithms that detect differences in occupancy at high speed. Examples of the algorithm include point cloud change detection and the like. In the present example embodiment, a method of calculating the occupancy difference is not limited.

In step S29 described above, in the present example embodiment, the evaluation unit 20 calculates the difference in occupancy as the evaluation value. In step S30 described above, the evaluation unit 20 evaluates whether the difference in occupancy satisfies the evaluation criterion. In step S31 described above, in the present example embodiment, the update unit 21 repeats an instruction to update the unknown state or the control plan while advancing the operation of the task (time evolution) until the evaluation value satisfies the evaluation criterion. Alternatively, the update unit 21 may repeat the update of the unknown state or the control plan.

In the present example embodiment, a case is considered in which assumption of the size and the friction coefficient of the picking object 32 is different as described above, and thus, for example, the update unit 21 may update control parameters such as the strength of closing the robot hand and the lifting speed, which are affected by the friction coefficient of the picking object 32, and recalculate the control plan, or may update parameters related to the location and the angle of gripping of the picking object 32, or may give such an instruction to the control unit 19.

(Effects of Third Example Embodiment)

According to the third example embodiment, in addition to being able to efficiently determine the abnormal state related to the target device, it is possible to automatically (autonomously) recover from the abnormal state to the normal state, and thus, it is possible to reduce the SI man-hours. The reason is that the evaluation unit 20 evaluates whether the evaluation value satisfies the evaluation criterion, and in a case where the evaluation criterion is not satisfied, the update unit 21 updates at least one of the estimation result and the control plan based on the evaluation value, whereby the observation information evaluation process is repeated until the evaluation value satisfies the evaluation criterion.

### FOURTH EXAMPLE EMBODIMENT

Next, as the fourth example embodiment, another specific example based on the second example embodiment will be described.

(System Configuration)

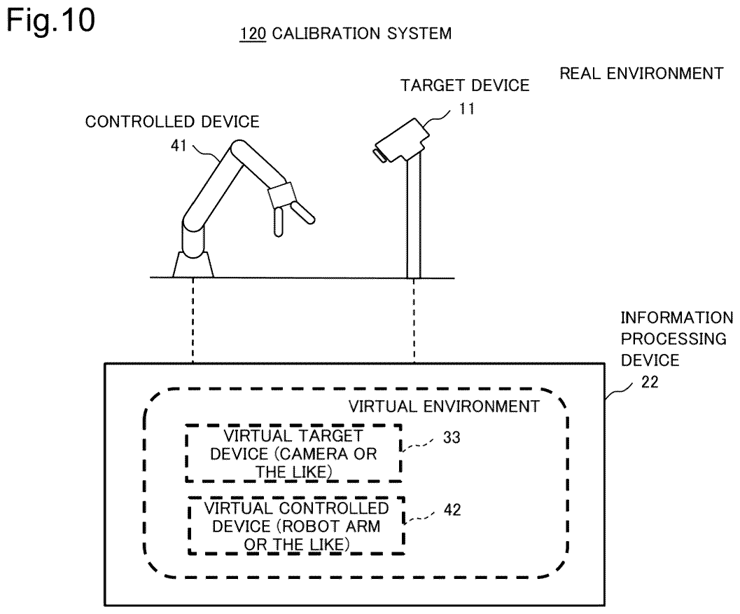

The fourth example embodiment is an example in which the observation device is evaluated as the target device 11 in the calibration in which the coordinate system of the observation device and the coordinate system of the robot arm are associated with each other. As a result of the calibration, the robot arm can be autonomously operated with reference to the image data of the observation device. In the present example embodiment, the observation device is the target device 11, and the robot arm is the controlled device. FIG. 10 is a diagram illustrating an example of a configuration of a calibration system 120 according to the fourth example embodiment.

As illustrated in FIG. 10, the calibration system 120 includes an observation device that is the target device 11, a robot arm that is an observation target to be observed by the observation device and is a controlled device 41 that executes a task, and the information processing device 22. The information processing device 22 constructs the virtual target device 33 that is a model of the observation device of the target device 11 and a virtual controlled device 42 that is a model of the controlled device 41 in the virtual environment.

The target device 11 is an object to be evaluated or an object for which an unknown state is estimated, and is also an observation means configured to output real observation information to the real environment observation unit 14. The robot arm that is the controlled device 41 operates based on the control plan of the control unit 19. Hereinafter, an example will be described in which the observation device that is the target device 11 is a camera, and the position/posture of the camera, that is, a so-called external parameter of the camera is estimated as an unknown state.

(Operation)

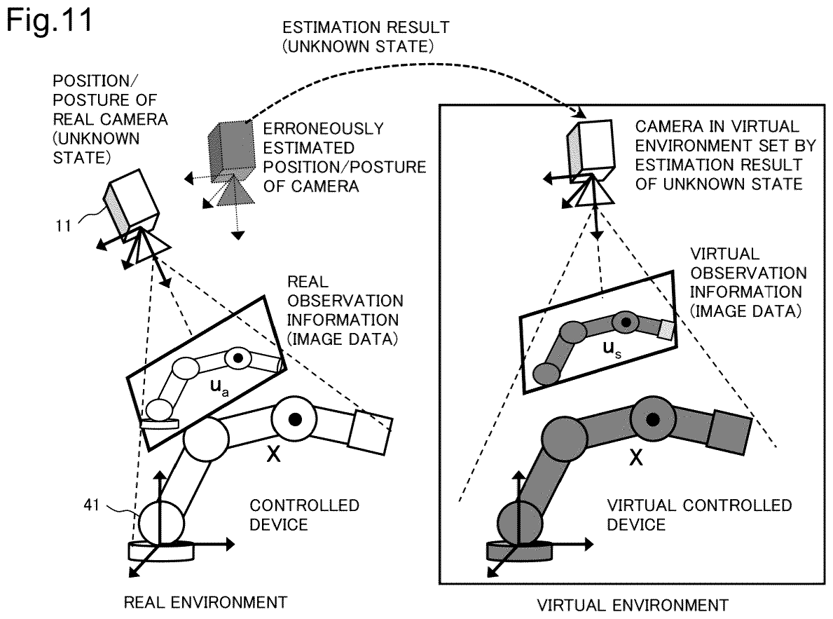

FIG. 11 is a diagram for explaining the operation of the calibration system 120 according to the fourth example embodiment. Hereinafter, the operation of the calibration system 120 will be described with reference to the flowchart illustrated in FIG. 6. As illustrated in FIG. 11, the left side is the real environment, and the right side is the virtual environment. The position/posture of the camera (target device 11) is represented by at least 6-dimensional parameters of three-dimensional coordinates representing the position of the camera and roll, pitch, and yaw representing the posture. In the present example embodiment, the position/posture of the camera is set as six-dimensional parameters. The unknown state of the present example embodiment is the position/posture of the camera. The way of representing the posture is not limited to this, and the posture may be represented by a four-dimensional parameter based on a quaternion, a nine-dimensional rotation matrix, or the like. When the posture is represented by the Euler angle (roll, pitch, yaw) as described above, the posture is represented in minimum three dimensions.

In step S21 described above, the real environment observation unit 14 of the information processing device 22 acquires the real observation information (image data) regarding the robot arm (controlled device 41) observed by the camera. The operation will be described assuming that there is an unknown state (YES in step S22 described above).

Next, in step S23 described above, the real environment estimation unit 15 estimates the position/posture of the camera that is an unknown state based on the acquired real observation information. A specific example of an unknown state estimation method in the case of calibration will be described later.

As illustrated in FIG. 11, in the present example embodiment, it is assumed that the robot arm is within the field of view of the camera in both the real environment and the virtual environment. The real observation information and the virtual observation information are assumed to be 2D (two-dimensional) as illustrated in FIG. 11.

In step S24 described above, the virtual environment setting unit 16 sets the estimation result of the unknown state in the virtual environment. In the present example embodiment, the virtual environment setting unit 16 sets the erroneously estimated position/posture for the camera model (virtual target device 33) in the virtual environment. In general, it is very difficult to accurately measure the position/posture of the camera from the beginning in such a way that the coordinate system of the camera and the coordinate system of the robot arm can be accurately associated with each other. Therefore, as illustrated in FIG. 11, the position/posture of the camera (virtual target device 33) in the virtual environment are assumed to be the position/posture of the camera erroneously estimated with respect to the real position/posture of the camera that is an unknown state in the real environment.

As a result, the real environment before the operation, that is, the initial state of the real environment is set in the virtual environment of the information processing device 22. That is, the virtual environment is set in such a way that calibration between the target device 11 and the controlled device 41 in the real environment can be similarly executed between the virtual target device 33 and the virtual controlled device 42 in the virtual environment.

After setting the virtual environment, in step S25 described above, the robot arm (controlled device 41) operates according to the control plan for calibration, and the camera (target device 11) observes the operation of the robot arm and executes calibration, which is a task. At this time, the real environment observation unit 14 acquires operation information about the robot arm from the robot arm (controlled device 41). The virtual environment setting unit 16 sets the operation information acquired by the real environment observation unit 14 for the virtual controlled device 42. As a result, in the virtual environment, the virtual controlled device 42 performs the same operation as the robot arm in the real environment by simulation. The virtual environment setting unit 16 may perform the same operation as the robot arm in the real environment by setting a control plan for the virtual controlled device 42. In a case of setting the control plan for the virtual controlled device 42, it depends on the control model for the robot arm (virtual controlled device 42) in the virtual environment. That is, in a case where the robot arm (controlled device 41) in the real environment cannot be completely modeled, the error is included. Therefore, such an error can be eliminated by moving (synchronize) the robot arm in the virtual environment based on the operation information such as the values of the joints and the actuators acquired from the robot arm in the real environment.

In step S27 described above, the real environment observation unit 14 acquires the real observation information from the camera. The virtual target device 33 observes the state of the virtual controlled device 42 to output virtual observation information related to the virtual controlled device 42 to the virtual environment observation unit 17.

As described above, while the position/posture of the camera (target device 11) is an unknown state, the real observation information (image data) obtained by the camera is acquired with the position/posture of the real camera. On the other hand, the virtual observation information is different from the real observation information because the virtual observation information is acquired with the position/posture of the virtual target device 33 for which the wrong estimation result is set. FIG. 11 illustrates an example in which 2D (two-dimensional) real observation information and virtual observation information are different.

For the sake of explanation, it is assumed that a feature point on the controlled device 41 and a feature point on the virtual controlled device 42 related to the feature point are X represented by the coordinate system of each of the controlled device 41 and the virtual controlled device 42, that is, the coordinate system of the robot arm. The feature point is any feature point as long as it is a portion that can be easily discriminated in the image, and an example thereof includes a joint. It is assumed that the feature point of the real observation information is ua expressed in the camera coordinate system. It is assumed that the feature point of the virtual observation information is represented by us in the camera coordinate system. Assuming that a matrix representing conversion between the coordinate system of the robot arm and the camera coordinate system, that is, a so-called camera matrix, is Za and Zs in the real environment and the virtual environment, respectively, ua and us are expressed by the following Expression. The camera matrix includes an internal matrix and an external matrix. The internal matrix represents internal parameters such as the focal point and the lens distortion of the camera. The external matrix represents external parameters such as translational movement and rotation of the camera, a so-called position/posture of the camera.

[Math. 1]

uₐ=ZₐX,uₛ=ZₛX (Expression 1)

While the feature point X is the same point in the real environment and the virtual environment, the camera matrix Za of the camera (target device 11) in the real environment is different from the camera matrix Zs of the camera (virtual target device 33) in the virtual environment before calibration. Therefore, the feature points uₐ and uₛ on the image data expressed by Expression 1 are different, and the square error thereof is expressed by the following Expression.

[Math. 2]

|uₐ−uₛ|²=|ZₐX−ZₛX|² (Expression 2)

Therefore, the relationship of the error represented by Expression 2 can be applied to the calculation of the evaluation value. That is, the position/posture of the camera that is an unknown state, that is, the external matrix of the camera matrix may be estimated in such a way that the evaluation value, that is, the error (|uₐ−uₛ|) between the positions of the feature points X in the mutual environments converted via the camera matrix is small. In the present example embodiment, it is assumed that the internal matrix is a known state.

In step S28 described above, the comparison unit 18 compares the real observation information and the virtual observation information, and calculates the difference in occupancy. Then, in step S29 described above, the evaluation unit 20 calculates the difference in occupancy as the evaluation value, and in step S30 described above, determines whether the difference in occupancy satisfies the evaluation criterion.

Hereinafter, an example in which the real observation information and the virtual observation information as illustrated in FIG. 11 are input to the comparison unit 18, and the evaluation unit 20 calculates the evaluation value will be described.

FIG. 12 is a diagram for explaining the operation of the comparison unit 18 according to the fourth example embodiment. As in the third example embodiment, FIG. 12 illustrates an example in which when the real observation information and the virtual observation information are 2D (two-dimensional) image data, the real observation information and the virtual observation information are converted into occupancy and compared. Also in this case, 3D (three-dimensional) data may be used as the real observation information and the virtual observation information. In FIG. 12, the expression of the occupancy and the illustration of the occupied or the unoccupied are similar to those in FIG. 9 of the third example embodiment. In the present example embodiment, the resolution at the time of conversion into the occupancy, that is, the grid size is changed. Specifically, at first, the update of the unknown state is roughly performed based on the evaluation value, that is, the difference in occupancy, in a case where the grid size is large. When the evaluation value decreases, that is, when the difference in the image data between the real observation information and the virtual observation information decreases, the grid size is reduced, and iteration of continuing the update of the unknown state is performed. A method of changing the grid size is not particularly limited, and for example, the grid size can be set based on a ratio between an evaluation value in a previous iteration and a current evaluation value, or can be set based on a ratio at which a sample is accepted to be described later.

Such iteration processing is performed together with the processes of the comparison process in step S28 to the evaluation process in step S30 in the observation information evaluation process flow illustrated in FIG. 6. That is, when the difference in occupancy satisfies the evaluation criterion in the evaluation process in step S30 with the grid size set in the comparison process in step S28, the grid size is reduced, and the processes of the comparison process in step S28 to the evaluation process in step S30 are performed. At this time, when the evaluation value does not satisfy the evaluation criterion in step S30, the processing from step S31 is repeated. Then, even when the grid size is reduced, when the evaluation values continuously satisfy the evaluation criterion, the process ends. The number of times of satisfying the evaluation criterion continuously may be determined according to the accuracy of the position/posture of the camera that is an unknown state, and is not limited.

The reason why the grid size is gradually reduced by iteration and comparison is performed will be described. An object of the present example embodiment is to obtain an unknown state, that is, the position/posture of the camera that is the target device 11. In a state where the position/posture are correct, the real observation information and the virtual observation information illustrated in FIG. 12 match. In other words, as the error (|uₐ−uₛ|) between the transformed coordinates between the feature points X on the image data in the mutual environments expressed by Expression 2 approaches 0 (zero), the obtained position/posture is a correct state. Therefore, as in the third example embodiment, the position/posture of the camera (target device 11) that is an unknown state may be updated based on the difference in occupancy. However, in the case of the calibration of the present example embodiment, the difference in occupancy as the evaluation value is a one-dimensional quantitative value, whereas the position/posture of the camera has at least six-dimensional values, that is, at least six parameters. Therefore, in estimating the position/posture of the camera, it is difficult to determine an appropriate and efficient change width of each parameter that can be updated in such a way as to approach the parameter of the correct position/posture. The difference in occupancy refers to the number (percentage) of unmatched grids among the occupied grids, that is, the number of different occupied grids.

For example, as illustrated in FIG. 12, in the large grid size of 3×3 (upper stage), the position/posture (estimation result) of the camera (virtual target device 33) is deviated from the camera (target device 11), that is, the camera matrices Za and Zs expressed by Expression 1 are different, and thus, a difference occurs between the real observation information and the virtual observation information. In this example, the occupied grids in the real observation information are compared with the occupied grids in the virtual observation information, and the number of occupied grids that are not spatially matched is five (a difference ratio of 5/9). Therefore, in the large grid size, the update unit 21 updates the unknown state or gives an instruction of update, and repeats steps S25 to S31 until the difference in occupancy satisfies a certain criterion. The criterion is an allowable range described later, and details will be described later.

Next, in the large grid size, when the difference in occupancy satisfies the criterion, the update unit 21 decreases the grid size. The grid size is middle of 4×4. Then, as in the large grid size, until the difference in occupancy satisfies the evaluation criterion in the middle grid size, the update unit 21 updates the unknown state or instructs the update, and repeats the comparison process and the evaluation process. At this point, as illustrated in (middle part of) the middle grid size in FIG. 12, the deviation between the position/posture (estimation result) of the camera (virtual target device 33) and the camera (target device 11) is smaller than the deviation illustrated in the large grid size (upper part). As a result, the number of occupied grids that are not spatially matched is four (a difference ratio of 4/16) in the occupied grids in the real observation information and the occupied grids in the virtual observation information. That is, the ratio of the difference is small.

Furthermore, in order to reduce the deviation of the estimation result of the position/posture of the camera, the update unit 21 sets the grid size to be small of 6×6. The number of occupied grids that are not unmatched is three (a difference ratio 3/36) in the occupied grids in the real observation information and the occupied grids in the virtual observation information at this time. In the small grid size, the update unit 21 updates the unknown state or instructs the update, and repeats steps S25 to S31 until the difference in occupancy satisfies the criterion. The evaluation criterion has different values for respective grid sizes.

For the update of the unknown state, that is, the position/posture of the camera, for example, a parameter with high sensitivity among the parameters of the position/posture of the camera may be updated by the above-described gradient method.

In this way, by performing the iteration while changing the grid size, it is possible to prevent the solution or the local solution in which the estimation result is greatly deviated. The accuracy of the finally obtained position/posture depends on the final grid size. Therefore, the grid size may be set according to the accuracy of the necessary position/posture. The method of changing the resolution or the grid size is an example and is not limited.

Next, as another example of the method of estimating the position/posture of the camera described above, a method of stochastically expressing and estimating a parameter representing the position/posture of the camera will be described. This method is a method suitable as a method for estimating a high-dimensional parameter in a case where the evaluation value has a low dimension, such as the difference in occupancy as described above.

The distribution of the position/posture parameter θ when the difference in occupancy ρ satisfies the allowable range ε can be expressed by a conditional probability of the following Expression, where θ is a parameter representing the position/posture of the camera (position/posture parameter θ), φ is a parameter representing the grid size (lattice size φ), ρ is a difference in occupancy, and ε is an allowable range (tolerance) that the difference should satisfy (allowable range ε).

[Math. 3]

p(θ|ρ(θ,φ)<ε) (Expression 3)

This method is based on a method called approximate Bayesian computation (ABC), and is used as an approximate method in a case where a value of likelihood cannot be calculated by a general Bayesian statistics method. That is, this method is suitable for the case as in the present example embodiment. The above-described method is an example of an estimation method, and is not limited thereto.

(Estimation Processing of Position/Posture Parameter θ)

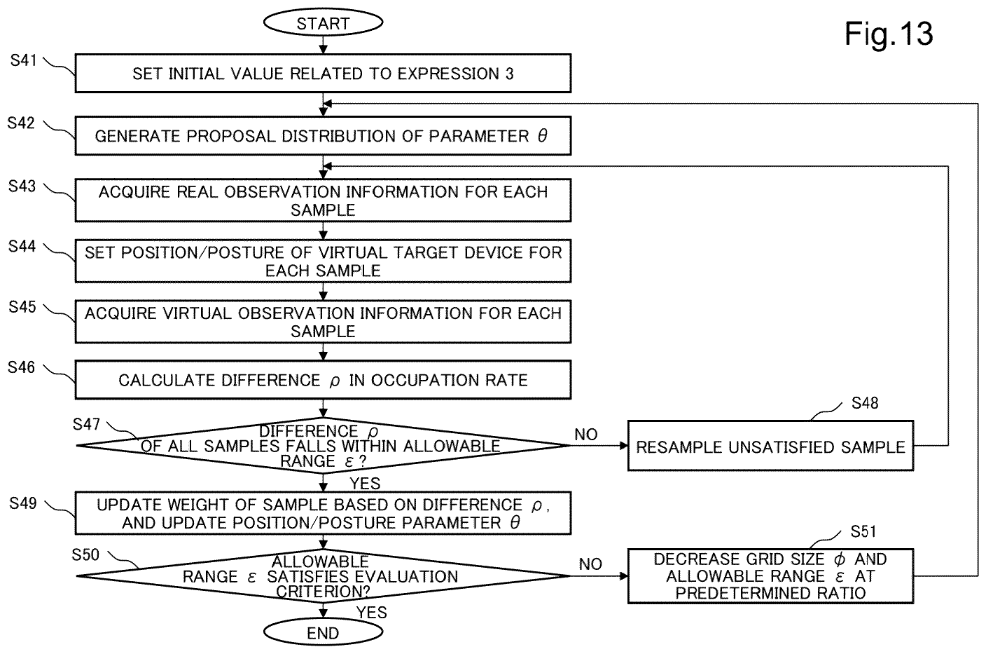

A specific estimation method of the position/posture parameter θ based on Expression 3 will be described with an example of a processing flow illustrated in FIG. 13. FIG. 13 is a flowchart illustrating estimation processing of the position/posture parameter θ according to the fourth example embodiment. Hereinafter, as a method of bringing the allowable range ε close to the target distribution while gradually reducing the allowable range ε, a method combining a sequential Monte Carol (SMC) method or a method called a particle filter will be described. However, this is an example of the method, and the present invention is not limited thereto. Hereinafter, a certain parameter θ sampled from the probability distribution of the parameter θ is expressed as a sample (particle). The difference ρ in the occupancy is determined by the position/posture parameter θ and the grid size φ as illustrated in Expression 3. where θ is an estimated value (estimation result), and φ is a given value.

First, the real environment estimation unit 15 sets the initial distribution of the position/posture parameter θ, the weight of the sample, the grid size φ, and the initial value of the allowable range ε (step S41). It is assumed that the weight of the sample is normalized in such a way that the sum of all samples is 1. The initial distribution of the position/posture parameter θ may be, for example, a uniform distribution of a certain assumed range. The initial sample weights may all be equal, i.e., the inverse of the number of samples (particle number). The grid size φ and the allowable range ε may be appropriately set based on the resolution and the like of the target device 11, that is, the camera, the size and the like of the controlled device 41, and the like.

Next, the real environment estimation unit 15 generates a probability distribution, that is, a proposal distribution of the position/posture parameter θ under the weight of a given sample and the grid size φ (step S42). For the proposal distribution, for example, the distribution is assumed to be a normal distribution (Gaussian distribution), the average value of the distribution can be determined from the average value of the samples, and the variance covariance matrix can be determined from the variance of the samples.

Then, the real environment observation unit 14 acquires a plurality of samples according to the proposal distribution, and acquires real observation information from the target device 11 for each sample (step S43). Specifically, the real environment observation unit 14 acquires real observation information from the target device 11 based on the position/posture parameter θ for each sample, and performs coordinate conversion on the real observation information based on Expression 1. That is, the real environment observation unit 14 converts the real observation information about the camera coordinates into the real observation information about the robot arm for each sample.

Next, the virtual environment setting unit 16 sets the position/posture of the virtual target device 33 based on the position/posture parameter θ for each sample acquired by the real environment observation unit 14 (step S44). The virtual environment observation unit 17 acquires virtual observation information from the virtual target device 33 for each sample (step S45). Specifically, the virtual environment observation unit 17 acquires virtual observation information from the virtual target device 33 for which the position/posture parameters θ for each sample is set, and performs coordinate conversion on the virtual observation information based on Expression 1. That is, the virtual environment observation unit 17 converts the virtual observation information about the camera coordinates into the virtual observation information about the robot arm for each sample.

Then, the comparison unit 18 converts each of the real observation information and the virtual observation information into the occupancy under a given grid size φ, and calculates the occupancy difference ρ (step S46). The evaluation unit 20 determines whether the occupancy difference ρ falls within the allowable range ε (step S47).

When it is within the allowable range ε (YES in step S47), the evaluation unit 20 accepts the sample and advances the process to step S48. When it is not within the allowable range ε (step S47, NO), the evaluation unit 20 rejects the sample that has not been accepted, and resamples the sample according to the rejected sample from the proposal distribution (step S48). That is, when the sample is rejected, the evaluation unit 20 requests the real environment estimation unit 15 to perform resampling. Then, the evaluation unit 20 repeats this operation until the difference ρ in occupancy of all the samples falls within the allowable range ε. However, in this repetitive processing, after resampling in step S48, no sample is acquired in step S43. In practical use, in a case where repeating until all the samples fall within the allowable range causes a temporal problem, measures may be added in such a way as to facilitate acceptance, such as performing a process of terminating (timing out) at a prescribed number of times of sampling, increasing the value of the grid size or increasing the value of the allowable range at a prescribed number of times of sampling or more.

The update unit 21 updates the weight of the sample based on the occupancy difference p, and also updates the position/posture parameter θ (step S49). The update of the sample weight may be set based on, for example, a reciprocal of the occupancy difference ρ in order to increase a weight of a sample with a small occupancy difference p, that is, with reliability. The weight of the sample is normalized in such a way that the sum of all the samples is 1.

When the allowable range ε does not satisfy the evaluation criterion (when the allowable range ε is greater than the threshold value) (step S50), the update unit 21 reduces the grid size φ and the allowable range ε at a predetermined ratio (step S51). In this case, the evaluation criterion (threshold value) is defined as the minimum value after gradually decreasing the allowable range ε. When the allowable range ε of Expression 3 is sufficiently small, the accuracy of the parameter θ to be estimated is also high, but since the rate of acceptance is low, estimation may be inefficient. Therefore, it is possible to apply a method (iteration) of repeatedly performing the above estimation while decreasing the value of the allowable range ε from a large value at a predetermined ratio. That is, the allowable range ε of Expression 3 has a magnitude relationship such as ε_1>ε_2>>ε_N when the number of times of iteration is i (i=1, 2, N: N is a natural number), and the allowable range ε_N of the last iteration is set as the evaluation criterion (threshold value) and the processing is terminated when this value is reached.

The ratio at which the grid size φ and the allowable range ε are reduced may be appropriately set based on the result of the flow described above, such as the resolution of the target device 11, that is, the camera, the size of the controlled device 41, and the ratio at which the sample is received.

From the above, the updated position/posture parameter θ when the allowable range ε finally satisfies the evaluation criterion (is equal to or less than the threshold value) is the desired position/posture of the camera. However, the above setting and estimation method are merely examples, and the present invention is not limited thereto.

According to the estimation processing flow of the position/posture parameter θ illustrated in FIG. 13, evaluation of the target device 11 can be performed with high accuracy with efficient calculation, that is, with less calculation resources or less calculation time. In other words, the present example embodiment can provide a system that performs calibration with high accuracy. The reason is that, in general, in the ABC method based on Expression 3, when the allowable range ε is large, the calculation efficiency increases because the sample is easily received, but the estimation accuracy decreases. On the other hand, when the allowable range ε is small, in the ABC method, the calculation efficiency decreases because the sample is hardly received, but the estimation accuracy is improved. As described above, the ABC method has a trade-off relationship between calculation efficiency and estimation accuracy.

Therefore, in the estimation processing of the present example embodiment, as illustrated in FIG. 13, a processing flow is used in which while the allowable range ε is gradually reduced starting from a large value, the grid size φ contributing to the occupancy difference ρ is similarly gradually reduced starting from a large value, and the weight of the sample is set based on the occupancy difference p.

As a result, the estimation processing of the present example embodiment can calculate the estimated value with high accuracy by increasing the acceptance rate of the sample under the large allowable range ε and the large grid size φ at the initial stage of estimation, roughly narrowing down the estimated value that is the estimation result, and finally decreasing the allowable range ε and the grid size cp. As a result, the trade-off is resolved.

In the calibration of the present example embodiment, it is not necessary to use a sign such as an AR marker that is essential in a known method. This is because the evaluation method based on the real environment and the virtual environment of the present disclosure is applied. Specifically, in a known method, it is necessary to associate a reference point of a controlled device with a reference point obtained by imaging the reference point with an imaging device. Therefore, in the known method, some kind of mark or feature point is required for the association. Installing such a sign in advance or deriving the feature point increases the number of the preset SI steps, and at the same time, depending on the installation method and the method of selecting the feature point, there is a possibility that the accuracy is lowered.

(Effects of Fourth Example Embodiment)

According to the fourth example embodiment, in addition to efficiently determining the abnormal state related to the target device, the position/posture of the target device 11 that is autonomously the unknown state can be accurately calculated. The reason is that the evaluation unit 20 evaluates whether the evaluation value satisfies the evaluation criterion, and in a case where the evaluation criterion is not satisfied, the update unit 21 updates at least one of the estimation result and the control plan based on the evaluation value, whereby the observation information evaluation process is repeated until the evaluation value satisfies the evaluation criterion.

That is, by focusing on the difference in occupancy in the comparison between the real observation information and the virtual observation information, it is possible to accurately calculate the position/posture by evaluating the unknown state of the camera as the target device, that is, the reliability of the position/posture, and updating the position/posture in a reliable direction.

According to the fourth example embodiment, as described above, by setting the reference point (feature point) on the controlled device, it is possible to associate the reference points in the real environment and the virtual environment with each other while operating the controlled device based on an any control plan. As a result, in the calibration of the present example embodiment, since the reference points in the mutual environments can be associated with each other at an any place in the operation space of the controlled device, it is possible to associate the reference points with suppressed spatial deviation and error of the estimation result. Therefore, it is possible to provide a calibration system capable of automatically associating the coordinate system of the observation device with the coordinate system of the robot arm without performing a hardware setting such as installation of a sign or setting a software condition for detecting an abnormal state for the target device to be evaluated or the controlled device.

(Modification)

Heretofore, passive calibration in a case where the controlled device 41 to be calibrated, that is, the robot arm is stationary or in a case where an any operation such as a task is performed is described. Hereinafter, as a modification of the fourth example embodiment, an example of a method of actively changing the position/posture of the robot arm based on the evaluation value and the like will be described.

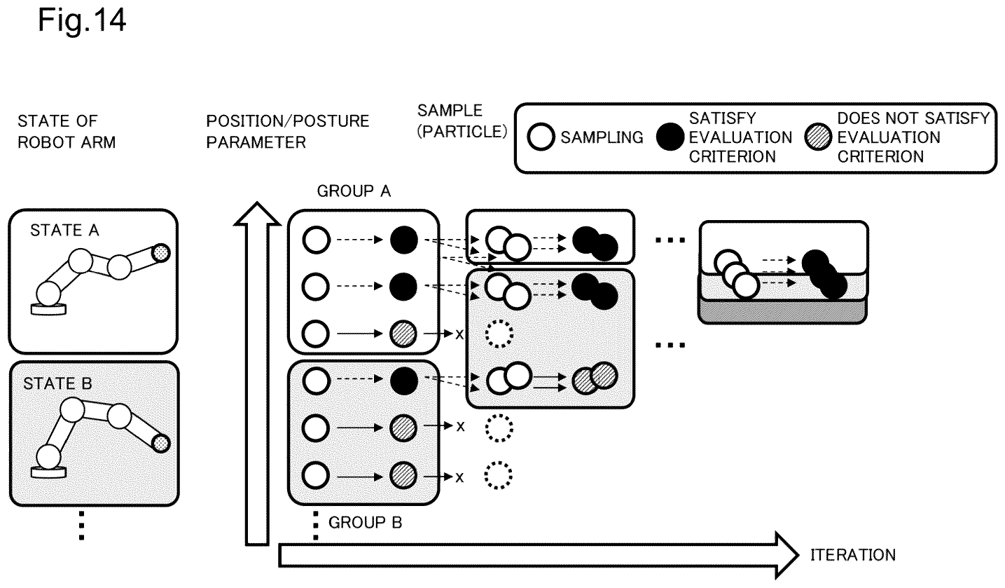

FIG. 14 illustrates an example in which the calibration of the present example embodiment is performed by changing the position/posture of the robot arm based on the ratio satisfying the evaluation criterion. FIG. 14 is a diagram illustrating a calibration method in a modification of the fourth example embodiment.

As illustrated in FIG. 14, the horizontal axis represents the number of iterations, and the vertical axis schematically represents the position/posture parameter (unknown state) to be estimated in one dimension. Each position/posture parameter is represented by a sample (particle), and each particle has information about a six-dimensional position/posture parameter. Samples are divided into a group according to the prescribed number of samples, and each group is associated with the state of the robot arm illustrated on the left. In the example of FIG. 14, samples belonging to a certain group A are sampled in the state A of the robot arm, and samples belonging to a certain group B are sampled in the state B of the robot arm.

As described above, ideally, all samples are accepted to satisfy the allowable range. However, practically, in a case where the sampling is terminated at a specific number of times, a sample not satisfying the allowable range, that is, a sample of an inappropriate position/posture parameter remains. Such a sample can be weighted smaller to discard in the next iteration, and instead duplicate samples that have satisfied the allowable range. In the particle filter, such an operation is referred to as resampling.

The ratio satisfying the allowable range or the ratio not satisfying the allowable range is studied for each group related to the state of the robot arm. For example, when there are many samples that do not satisfy the allowable range in the state B of a certain group B, a reliable value of the position/posture parameter cannot be sufficiently obtained for the state B. Therefore, in the next iteration, for example, the allocation of the sample of the group A having many samples satisfying the allowable range may be changed as a sample of the group B, and the evaluation may be performed on the state B. As illustrated in FIG. 14, the ratio of samples satisfying the allowable range increases and the ratio of samples not satisfying the allowable range decreases as the iteration proceeds. In this case, in the next iteration, more samples are allocated from the group in which the ratio satisfying the allowable range is high to increase the number of times of sampling, so that it is easy to obtain a reliable position/posture parameter.

By introducing such processing, as the iteration progresses, as illustrated at the right end of FIG. 14, it can be expected that samples satisfying the allowable range in each group approach a specific value. This means that samples which satisfies an allowable range and that do not depend on the group, that is, the position/posture of the robot arm is obtained. Therefore, there is an effect that a global estimated value that does not depend on the position/posture of the robot arm, that is, has no spatial dependency can be obtained. Conversely, in the absence of such processing, even when the position/posture of a specific robot arm is appropriate, when the position/posture of the robot arm change, inappropriate estimation, that is, local estimation in which the calibration is deviated may be obtained.

### FIFTH EXAMPLE EMBODIMENT

(System Configuration)

Next, another specific example based on the second example embodiment will be described as the fifth example embodiment.

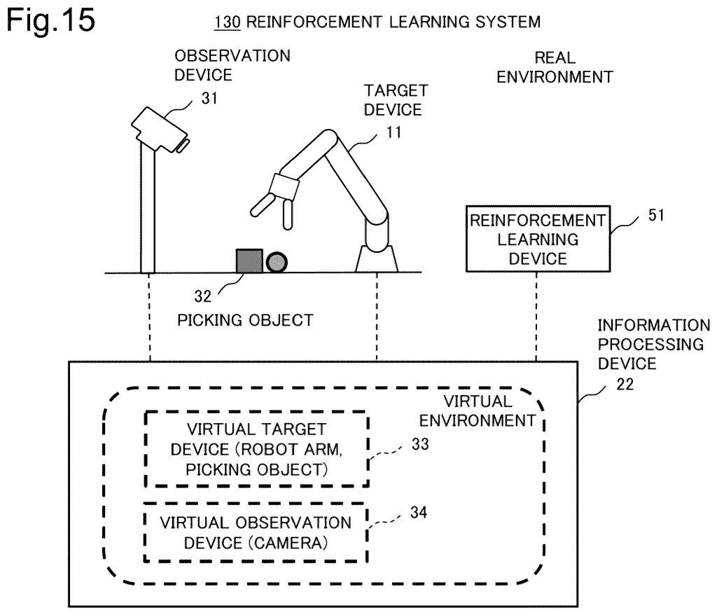

The fifth example embodiment is an example of a system that performs reinforcement learning on a target device. In this case, as in the third example embodiment, the target device 11 to be evaluated is a robot arm, and the observation device 31 is a camera. FIG. 15 is a diagram illustrating a configuration of a reinforcement learning system 130 according to the fifth example embodiment.

The reinforcement learning system 130 illustrated in FIG. 15 includes a reinforcement learning device 51 in addition to a robot arm that is the target device 11, the observation device 31 that obtains real observation information about the target device 11, the picking object 32, and the information processing device 12, as in the third example embodiment. Hereinafter, a case where picking reinforcement learning, which is an example of a task, is performed based on the evaluation value of the target device 11 will be described as an example. However, in the present example embodiment, the task is not limited.

(Operation)

The reinforcement learning system 130 can obtain, as an evaluation value, whether the real observation information and the virtual observation information are different states after a task, that is, an operation of picking, by a configuration similar to that of the third example embodiment except for the reinforcement learning device 51. The reinforcement learning system 130 sets this evaluation value as a reward value in the framework of reinforcement learning.

Specifically, the reinforcement learning system 130 sets a high reward (alternatively, a low penalty is set) in a case where there is no difference between the real environment and the virtual environment, that is, in a case where an operation in the real environment can be performed in the same manner as the ideal operation in the virtual environment based on the control plan. On the other hand, as described in the third example embodiment, in a case where there is a difference between the real environment and the virtual environment, such as a case where picking fails in the real environment, the reinforcement learning system 130 sets a low reward (alternatively, a high penalty is set). However, the setting of the reward is an example, and the reinforcement learning system 130 may express the value of the reward or the penalty as a continuous value based on, for example, quantitative information about a difference between the real environment and the virtual environment. Instead of evaluation before and after the task, the reinforcement learning system 130 may perform evaluation in accordance with a temporal operation state of the target device 11, that is, the robot arm, and set a time-series reward or penalty value. Setting of the reward or the penalty is not limited to the above.

Hereinafter, as an example of a framework of reinforcement learning, an example of learning a stochastic operation guideline (policy) π_θ parameterized by a certain parameter θ will be described. This parameter θ is independent of the position/posture parameter θ as described above. The following processing may be performed by the added reinforcement learning device 51 or the update unit 24. The evaluation value J of the operation determined by the policy π_θ is calculated based on the reward value R set as described above.

[Math. 4]

J(θ)∝R (Expression 4)

By the gradient of the evaluation value J and a certain coefficient (learning rate) α, the policy π_θ can be updated to be expressed by the following Expression.

[Math. 5]

π_θ←π_θ+α∇J(θ) (Expression 5)

Therefore, the policy π_θ can be updated in a direction in which the evaluation value J increases, that is, in a direction in which the reward increases. As another representative reinforcement learning method, a method based on value repetition, a method using deep learning (deep Q-network (DQN)), or the like can also be applied, and the present invention is not limited to the present disclosure.

In summary, the reinforcement learning device 51 sets a reward (or penalty) according to a difference between the real environment and the virtual environment, and creates a policy for the operation of the target device 11 in such a way that the set reward is higher. The reinforcement learning device 51 determines the operation of the target device 11 according to the created policy, and causes the target device 11 to perform the operation.

(Effects of Fifth Example Embodiment)

The picking system 110 of the third example embodiment not including the reinforcement learning device 51 can detect an abnormal state by observing the current state, update at least one of the unknown state and the control plan, and resolve the abnormal state. However, since the solution of the abnormal state is a post-response after the abnormal state is detected, the picking system 110 cannot be used when no attempt for the abnormal state is allowed, or even a few attempts are not allowed.

On the other hand, according to the present example embodiment, the stochastic policy function π_θ (a|s) represents the posterior distribution of the action (operation) a when the state s (state of environment including robot arm, camera, and the like) is given, and the parameter θ related to the determination is updated in such a way that the reward is high, that is, the appropriate action is performed. The state s can also include an unknown state estimated by the real environment estimation unit 15. Therefore, the parameter θ in consideration of the change in the observed state is learned. That is, even in a different environmental state, it is possible to perform an operation with a high reward from the beginning, in other words, without occurrence of an abnormal state, by using the learned parameter θ. That is, for example, in the case of the picking operation of the third example embodiment, when the real observation information or the estimation result, and the relationship of the approach position and the angle at which the picking does not fail are learned once, the picking can be performed without failing from the first time thereafter.

In general, in reinforcement learning, as described above, it is important to appropriately obtain the evaluation for the operation, that is, the value of the reward, and in particular, it is not easy to appropriately obtain the value of the reward in the real environment. For example, as in the third example embodiment, when simply based on real observation information (imaging data) observed by the observation device 31, it is necessary to determine success or failure of a desired operation, that is, success or failure of a task from the imaging data by some processing, and to calculate a value of a reward.

However, the determination of the success or failure of the operation based on the imaging data depends on the algorithm, and there is a possibility that an error occurs at the time of determination. On the other hand, according to the evaluation method regarding the target device of the present example embodiment, the value of the reward can be uniquely obtained based on the difference between the real environment and the virtual environment. In the evaluation method, it is not necessary to set a criterion or a rule for determining the operation in advance. Therefore, in reinforcement learning that requires acquisition of a reward value by enormous trials, the acquired reward value has high accuracy and reliability, and there is no preset, bringing a great effect. Therefore, according to the present example embodiment, it is possible to provide a reinforcement learning system capable of performing efficient reinforcement learning by obtaining an evaluation value for a target device with high accuracy and reliability even in a case where a criterion or a rule for evaluation are not set in advance for the target device to be evaluated.

### SIXTH EXAMPLE EMBODIMENT

Next, the sixth example embodiment will be described.

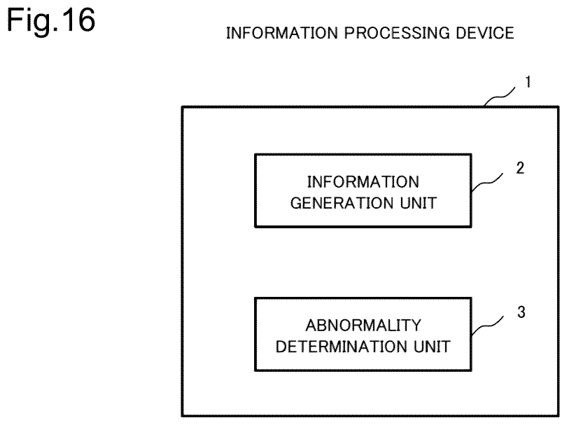

FIG. 16 is a block diagram illustrating a configuration of an information processing device 1 according to the sixth example embodiment. The information processing device 1 includes an information generation unit 2 and an abnormality determination unit 3. The information generation unit 2 and the abnormality determination unit 3 are example embodiments of an information generation means and an abnormality determination means of the present disclosure, respectively. The information generation unit 2 corresponds to the real environment observation unit 14, the real environment estimation unit 15, the virtual environment setting unit 16, and the virtual environment observation unit 17 of the first example embodiment, and the abnormality determination unit 3 corresponds to the comparison unit 18 of the first example embodiment. The information generation unit 2 corresponds to the real environment observation unit 14, the real environment estimation unit 15, the virtual environment setting unit 16, the virtual environment observation unit 17, and the control unit 19 of the second example embodiment, and the abnormality determination unit 3 corresponds to the comparison unit 18, the evaluation unit 20, and the update unit 21 of the second example embodiment.

The information generation unit 2 generates virtual observation information obtained by observing results from simulating a real environment in which a target device to be evaluated is present. The abnormality determination unit 3 determines an abnormal state related to the difference between the generated virtual observation information and real observation information obtained by observing the real environment.

(Effects of Sixth Example Embodiment)

According to the sixth example embodiment, it is possible to efficiently determine the abnormal state related to the target device. This is because the information generation unit 2 generates virtual observation information obtained by observing a result of simulating the real environment in which the target device to be evaluated exists, and the abnormality determination unit 3 determines an abnormal state according to a difference between the generated virtual observation information and the real observation information obtained by observing the real environment.

(Hardware Configuration)

In each of the above-described example embodiments, each component of the information processing device 12 and the target device 11 indicates a block of a functional unit. Part or all of each component of each device may be achieved by an any combination of a computer 500 and the program. This program may be recorded in a non-volatile recording medium. The non-volatile recording medium is, for example, a compact disc read only memory (CD-ROM), a digital versatile disc (DVD), a solid state drive (SSD), or the like.

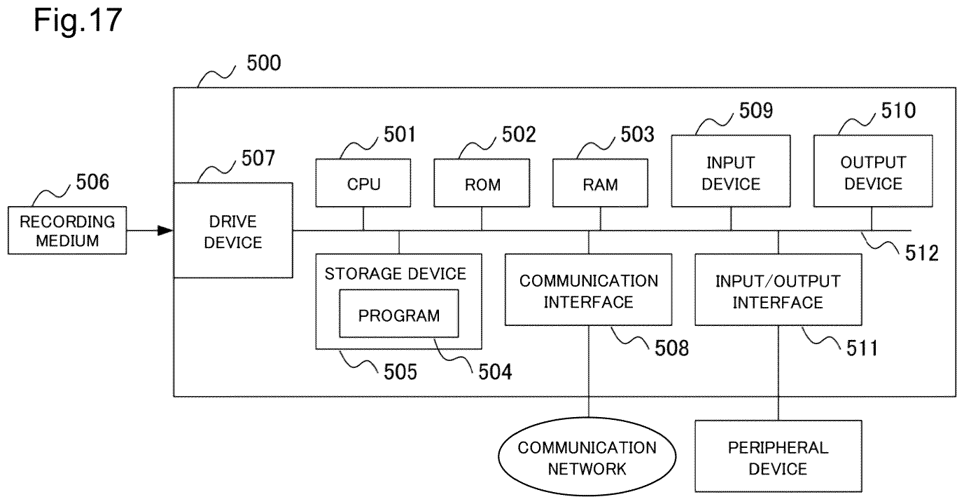

FIG. 17 is a block diagram illustrating an example of a hardware configuration of the computer 500. Referring to FIG. 16, the computer 500 includes, for example, a central processing unit (CPU) 501, a read only memory (ROM) 502, a random access memory (RAM) 503, a program 504, a storage device 505, a drive device 507, a communication interface 508, an input device 509, an output device 510, an input/output interface 511, and a bus 512.

The program 504 includes an instruction for achieving each function of each device. The program 504 is stored in advance in the ROM 502, the RAM 503, and the storage device 505. The CPU 501 achieves each function of each device by executing instructions included in the program 504. For example, the CPU 501 of the information processing device 12 executes instructions included in the program 504, thereby implementing the functions of the real environment observation unit 14, the real environment estimation unit 15, the virtual environment setting unit 16, the virtual environment observation unit 17, the comparison unit 18, the control unit 19, the evaluation unit 20, and the update unit 21. For example, the RAM 503 of the information processing device 12 may store the data of the real observation information and the virtual observation information. For example, the storage device 505 of the information processing device 12 may store the data of the virtual environment and the virtual target device 13.

The drive device 507 reads and writes the recording medium 506. The communication interface 508 provides an interface with a communication network. The input device 509 is, for example, a mouse, a keyboard, or the like, and receives an input of information from an operator or the like. The output device 510 is, for example, a display to output (display) information to an operator or the like. The input/output interface 511 provides an interface with a peripheral device. The bus 512 connects the respective components of the hardware. The program 504 may be supplied to the CPU 501 via a communication network, or may be stored in the recording medium 506 in advance, read by the drive device 507, and supplied to the CPU 501.

The hardware configuration illustrated in FIG. 17 is an example, and other components may be added or some components may not be included.

There are various modifications of the method for implementing the information processing device 12 and the target device 11. For example, the information processing device 12 may be achieved by an any combination of a computer and a program different for each component. A plurality of components included in each device may be achieved by an any combination of one computer and a program.

Some or all of the components of each device may be achieved by general-purpose or dedicated circuitry including a processor or the like, or a combination thereof. These circuits may be configured by a single chip or may be configured by a plurality of chips connected via a bus. Part or all of each component of each device may be achieved by a combination of the above-described circuit or the like and the program.

In a case where part or all of each component of each device is achieved by a plurality of computers, circuits, and the like, the plurality of computers, circuits, and the like may be disposed in a centralized manner or in a distributed manner.

Although the present disclosure is described with reference to the exemplary example embodiments, the present disclosure is not limited to the exemplary example embodiments. Various modifications that can be understood by those skilled in the art can be made to the configuration and details of the present disclosure within the scope of the present disclosure. The configurations in the respective example embodiments can be combined with each other without departing from the scope of the present disclosure.

### REFERENCE SIGNS LIST

10 target evaluation system
11 target device
12, 22 information processing device
13, 33 virtual target device
14 real environment observation unit
15 real environment estimation unit
16 virtual environment setting unit
17 virtual environment observation unit
18 comparison unit
19 control unit
20 evaluation unit
21 update unit
31 observation device
32 picking object
34 virtual observation device
35 virtual object
41 controlled device
42 virtual controlled device
50 reinforcement learning system
51 reinforcement learning device
110 picking system
120 calibration system

What is claimed is:

1. An information processing device comprising:
one or more memories storing instructions; and
one or more processors configured to execute the instructions to:
generate virtual observation information obtained by observing a result of simulating a real environment in which a target device to be evaluated exists; and
determine an abnormal state according to a difference between the virtual observation information and real observation information obtained by observing the real environment.

2. The information processing device according to claim 1, wherein the one or more processors are further configured to execute the instructions to:
set a virtual environment obtained by simulating a real environment based on the real observation information and an unknown state in the real environment, the unknown state being estimated based on the real observation information.

3. The information processing device according to claim 2, wherein the one or more processors are further configured to execute the instructions to:
estimate, as the unknown state, a state that is unknown or uncertain in the real environment and that is directly or indirectly estimatable from the real observation information.

4. The information processing device according to claim 3, wherein the one or more processors are further configured to execute the instructions to:
update at least one of the unknown state and a control plan for operating the target device based on a determination result of the abnormal state.

5. The information processing device according to claim 4, wherein the one or more processors are further configured to execute the instructions to:
repeat update of at least one of the unknown state and a control plan for operating the target device until a determination result of the abnormal state satisfies a predetermined criterion.

6. The information processing device according to claim 2, wherein the one or more processors are further configured to execute the instructions to:
acquire, as the real observation information, image information obtained by observing the target device,
generate, as the virtual observation information, image information of the same type as the real environment observed in the virtual environment, and
determine an abnormal state of the target device based on the real observation information and the virtual observation information.

7. The information processing device according to claim 1, wherein the one or more processors are further configured to execute the instructions to:
set a reward according to the difference, create a policy regarding an operation of the target device based on the reward, determine the operation of the target device according to the created policy, and cause the target device to perform the determined operation.

8. (canceled)

9. An information processing method, executed by a computer, comprising:
generating virtual observation information obtained by observing a result of simulating a real environment in which a target device to be evaluated exists; and
determining an abnormal state according to a difference between the generated virtual observation information and real observation information obtained by observing the real environment.

10. A recording medium that records a program for causing a computer to execute the steps of:
generating virtual observation information obtained by observing a result of simulating a real environment in which a target device to be evaluated exists; and
determining an abnormal state according to a difference between the generated virtual observation information and real observation information obtained by observing the real environment.
